(19) United States
(12) Patent Application Publication
(10) Pub. No.: US 2025/0229975 A1
(43) Pub. Date: Jul. 17, 2025

(54) VALVE SEAL AND VALVE INCLUDING SAME

(71) Applicant: Clayton Corporation, Fenton, MO (US)

(72) Inventors: Kevin Robert Martz, Desoto, MO (US); James P. McBroom, Byrnes Mill, MO (US)

(21) Appl. No.: 18/705,422

(22) PCT Filed: Oct. 27, 2022
(86) PCT No.: PCT/US2022/048015

§ 371 Date: Apr. 26, 2024

Related U.S. Application Data
(60) Provisional application No. 63/272,758, filed on Oct. 28, 2021.

(51) Int. Cl. B65D 83/44; B65D 83/46; B65D 83/48; F16J 15/3284

(52) U.S. Cl. CPC B65D 83/44; F16J 15/3284; B65D 83/46; B65D 83/48

(57) ABSTRACT

A seal for a valve for dispensing a flowable product from a pressurized container. The seal comprises a material comprising a thermoplastic elastomer (TPE) selected from the group consisting of thermoplastic polyamides (TPAs), thermoplastic copolyesters (TPCs), olefinic thermoplastic elastomer (TPOs), styrenic block copolymers (TPSs), thermoplastic urethanes (TPUs), thermoplastic vulcanizates (TPVs), or nonclassified thermoplastic elastomers (TPZs).

### FIELD

The present disclosure relates to a seal for a valve for dispensing a flowable product from a pressurized container.

### BACKGROUND

Valves for pressurized containers (e.g., aerosol containers) are well known. One well known valve includes a mounting cup, a stem, and a seal (e.g., a grommet) disposed between and interconnecting the stem and the mounting cup. The mounting cup has a generally cylindrical sidewall, a generally flat bottom wall, and an upper curled lip at an upper end of the sidewall. A central portion extends upward from a central region of the bottom wall and defines a mounting opening through which the seal and the stem extend. The mounting cup is received in an opening on top of the container, and the mounting cup is crimped (clinched) or otherwise attached to the container. The seal is made of a resilient material and has an elongate neck which extends through the mounting opening. A seal bead extends radially outward from the neck and overlies and presses against an upper peripheral edge of the central portion to secure the seal to the mounting cup. The stem includes an elongate tubular stem body with an outlet and inlet(s) (orifices) at the upper and lower ends, respectively, and a disc (or button) at the lower end of the stem body. The stem body snugly fits through a bore defined by the seal to form a seal therebetween. The disc seats against a seat portion of the seal to form a leak proof seal when the valve is in a non-actuated position. The disc is movable away from the seat portion in an actuated position to allow product in the container, via pressure inside the container, to flow between the disc and the seat portion and through inlet(s) of the stem. Depending on the actuator used to operate the valve, the valve may function as a “vertically actuated” valve, whereby an axial force is applied to the stem to unseat the disc from the seat portion of the seal, or alternatively, as a “tilt” valve, whereby a rotational force is applied to the side of the stem to unseat the disc.

However, a need remains in the art for an improved seal comprising economical and effective materials of construction. A need also exists for methods of preparing the improved seal such that the seal exhibits uniform properties and has an increased useable life.

### BRIEF DESCRIPTION OF THE DRAWINGS

FIG. 1 is a perspective of a valve for dispensing a flowable product from a pressurized container;

FIG. 2 is an exploded view of a valve showing a mounting cup, a seal, and a stem of the valve;

FIG. 3 is a cross section of a valve;

FIG. 4A is a cross section of a mounting cup;

FIG. 4B is a cross section of a mounting cup similar to the mounting cup of FIG. 4A;

FIG. 5 is a cross section of a seal;

FIG. 6 is a cross section of a container assembly including a valve and a pressurized container to which the valve is attached, the pressurized container being shown partially;

FIG. 7 is a cross section of a gun dispensing assembly including a valve, a pressurized container to which the valve is attached, a gun collar attached to the pressurized container, and a gun basket of the dispensing gun attached to the gun collar;

FIG. 8 is a cross section of a second valve;

FIG. 9 is an enlarged cross section of a mounting cup of the second valve;

FIG. 10 is a cross section of a third valve;

FIG. 11 is an enlarged cross section of a mounting cup of the third valve;

FIG. 12 is a cross section of a fourth valve;

FIG. 13 is an enlarged cross section of a mounting cup of the fourth valve;

FIG. 14 is a perspective of a fifth valve;

FIG. 15 is a front elevation of the fifth valve;

FIG. 16 is cross section of the fifth valve;

FIG. 17 is an enlarged cross section of a mounting cup of the fifth valve;

FIG. 18 is cross section of a sixth valve;

FIG. 19 is a cross section of a conventional valve;

FIG. 20 is a comparison of the conventional valve of FIG. 19 and the valve of FIG. 10;

FIG. 21 shows the dimensions of valves after crimping;

FIG. 22 is a perspective of a seventh valve;

FIG. 23 is an enlarged cross section of a mounting cup of the seventh valve;

FIG. 24 is a perspective of an eighth valve;

FIG. 25 is an enlarged cross section of a mounting cup of the eighth valve taken in a plane including opposite concave radial portions of a bottom wall of the mounting cup;

FIG. 26 is an enlarged cross section of the mounting cup of the eighth valve embodiment taken in a plane including opposite convex radial portions of a bottom wall of the mounting cup;

FIG. 27 is a perspective of a ninth valve;

FIG. 28 is an enlarged cross section of a mounting cup of the ninth valve.

Corresponding reference characters indicate corresponding parts throughout the drawings.

### DETAILED DESCRIPTION

The present disclosure is directed to a seal for a valve for dispensing flowable product from a container. A need exists for an improved seal comprising economical and effective materials of construction. The seal of the present disclosure may comprise a material comprising a thermoplastic elastomer (TPE) selected from the group consisting of thermoplastic polyamides (TPAs), thermoplastic copolyesters (TPCs), olefinic thermoplastic elastomer (TPOs), styrenic block copolymers (TPSs), thermoplastic urethanes (TPUs), thermoplastic vulcanizates (TPVs), or nonclassified thermoplastic elastomers (TPZs).

Further aspects of the present disclosure are directed to a process of preparing the seal and may include extrusion and/or mechanical grinding of a material comprising a thermoplastic elastomer (TPE) prior to formation of the seal.

Described below are exemplary configurations of a valve, container, and seal, wherein the valve is configured for dispensing flowable product from a container. It should be understood that use of the seal described herein is not limited to only the disclosed valve/container configurations.

The seal of the present disclosure may comprise a material comprising a thermoset rubber (e.g., vulcanized rubber, such as vulcanized neoprene rubber) or thermoplastic elastomer (TPE). The TPE may be selected from the group consisting of thermoplastic polyamides (TPAs), thermoplastic copolyesters (TPCs), olefinic thermoplastic elastomer (TPOs), styrenic block copolymers (TPSs), thermoplastic urethanes (TPUs), thermoplastic vulcanizates (TPVs), or nonclassified thermoplastic elastomers (TPZs). In certain embodiments, the TPE comprises a TPV. For example, the seal may comprise a material comprising a TPV that is a nitrile/polyolefin-based TPV. For example, the TPV may be a polyolefin-based TPV wherein the polyolefin is selected from the group consisting of polypropylenes, polyethylenes, and copolymers thereof.

In certain embodiments the seal may comprise a material comprising a thermoset rubber or thermoplastic elastomer (TPE) and an additional component. In one embodiment, the additional component may be a synthetic rubber. For example, the synthetic rubber may be selected from the group consisting of styrene-butadiene rubbers, polyisoprene, polychloroprene (neoprene), nitrile rubber, or combinations thereof. Polyisoprene, as used herein, should be understood to reference polymers that are produced by the polymerization of isoprene. Where noted, polyisoprene may refer to cis-1,4-polyisoprene. As used herein, nitrile rubber is understood to refer to acrylonitrile butadiene rubber.

The seal may comprise a material comprising a thermoplastic elastomer (TPE) and a synthetic rubber. For example, a TPE and a styrene-butadiene rubber, a TPE and a polyisoprene, a TPE and neoprene, a TPE and a nitrile rubber, or combinations thereof. In certain embodiments, the seal comprises a material comprising a TPA and a styrene-butadiene rubber, a TPA and a polyisoprene, a TPA and neoprene, a TPA and a nitrile rubber, or combinations thereof. In other embodiments, the seal comprises a material comprising a TPC and a styrene-butadiene rubber, a TPC and a polyisoprene, a TPC and neoprene, a TPC and a nitrile rubber, or combinations thereof. In further embodiments, the seal comprises a material comprising a TPO and a styrene-butadiene rubber, a TPO and a polyisoprene, a TPO and neoprene, a TPO and a nitrile rubber, or combinations thereof. In yet another embodiment, the seal comprises a material comprising a TPS and a styrene-butadiene rubber, a TPS and a polyisoprene, a TPS and neoprene, a TPS and a nitrile rubber, or combinations thereof. In one embodiment, the seal comprises a material comprising a TPU and a styrene-butadiene rubber, a TPU and a polyisoprene, a TPU and neoprene, a TPU and a nitrile rubber, or combinations thereof. In another embodiment, the seal comprises a material comprising a TPV and a styrene-butadiene rubber, a TPV and a polyisoprene, a TPV and neoprene, a TPV and a nitrile rubber, or combinations thereof. In yet another embodiment, the seal comprises a material comprising a TPZ and a styrene-butadiene rubber, a TPZ and a polyisoprene, a TPZ and neoprene, a TPZ and a nitrile rubber, or combinations thereof.

In one embodiment, the seal comprises a material comprising a TPV that is a nitrile/polyolefin-based TPV and a synthetic rubber selected from the group consisting of styrene-butadiene rubbers, polyisoprene, polychloroprene (neoprene), nitrile rubber, and combinations thereof. In certain specific embodiments, the seal comprises a material comprising a TPV that is a nitrile/polyolefin-based TPV and neoprene.

The seal may comprise a material comprising a thermoset rubber or thermoplastic elastomer (TPE) having suitable properties for attaching a valve to a container and dispensing a product (e.g., a flowable product) from the container. For example, the seal may comprise a thermoplastic elastomer having a density of about 0.90 g/cm³ or greater, about 0.92 g/cm³ or greater, about 0.94 g/cm³ or greater, about 0.96 g/cm³ or greater, about 0.98 g/cm³ or greater, about 1.00 g/cm³ or greater, about 1.01 g/cm³ or greater, about 1.02 g/cm³ or greater, about 1.03 g/cm³ or greater, about 1.04 g/cm³ or greater, or about 1.05 g/cm³ or greater. The seal may comprise a thermoplastic elastomer having a density of from about 0.90 to about 1.10 g/cm³, from about 0.92 to about 1.10 g/cm³, from about 0.94 to about 1.10 g/cm³, from about 0.94 to about 1.08 g/cm³, or from about 0.94 to about 1.06 g/cm³.

In one embodiment, the seal may comprise a thermoplastic elastomer having a Shore A hardness, based on ISO 868 test protocol, of about 40 or greater, about 45 or greater, about 50 or greater, about 55 or greater, about 60 or greater, about 65 or greater, about 70 or greater, about 75 or greater, about 80 or greater, about 85 or greater, or about 90 or greater. For example, a Shore A hardness of from about 40 to about 90, from about 45 to about 90, from about 45 to about 85, from about 50 to about 80, from about 55 to about 80, from about 60 to about 80, from about 65 to about 80, or from about 70 to about 80.

In some embodiment, the seal may comprise a thermoplastic elastomer having a brittleness temperature, based on ISO 812 test protocol, of about 0° C. or less, about −5° C. or less, about −10° C. or less, about −15° C. or less, about −20° C. or less, about −25° C. or less, about −30° C. or less, about −35° C. or less, or about −35° C. or less. For example, the seal may comprise a thermoplastic elastomer having a brittleness temperature from about 0° C. to about −35° C., from about −5° C. to about −35° C., from about −10° C. to about −35° C., from about −15° C. to about −35° C., from about −20° C. to about −35° C., or from about −25° C. to about −35° C.

In certain embodiments, the seal may be prepared by a process comprising extruding a material comprising a thermoset rubber or thermoplastic elastomer (TPE) and forming the seal.

The extrusion of the material comprising a thermoset rubber or TPE may be accomplished by any conventional extrusion device. For example, the extrusion device may be selected from the group consisting of single screw, twin screw, or multi-screw extruder. A twin screw extruder may be a conical twin screw or parallel twin screw extruder. A twin screw extruder may be a co-rotating or counter-rotating twin screw extruder.

In certain embodiments, the material comprising a thermoset rubber or TPE may be subjected to two or more extrusion steps. For example, in one embodiment, the material is passed through a first extrusion device to produce a first extruded material, the first extruded material is passed through a second extrusion device to produce a second extruded material, and the second extruded material is passed through a third extrusion device to produce a third extruded material. The third extruded material is then processed to form the seal. In another embodiment, the material is passed through a first extrusion device to produce a first extruded material and the first extruded material is passed through second extrusion device to produce a second extruded material. The second extruded material is then processed to form the seal.

Wherein the material comprising a thermoset rubber or TPE is subjected to two or more extrusion steps, the extrusion device of each step (i.e. the first, second, and/or third extrusion device) may be the same or different. For example, in one embodiment, the material is passed through an extrusion device to produce a first extruded material, the first extruded material is passed through the extrusion device a second time to produce a second extruded material, and the second extruded material is passed through the extrusion device a third time to produce a third extruded material.

The extruded material comprising a thermoset rubber or TPE may be formed into the seal by a process comprising extrusion, injection molding, compression molding, blow molding, melt calendaring, thermoforming, heat welding, or any combination thereof. In one embodiment, the extruded material comprising a thermoset rubber or TPE is formed into the seal by a process comprising injection molding.

In certain other embodiments, the material comprising a thermoset rubber or TPE may be subjected to mechanical grinding before the one or more extrusion steps of the process. Mechanical grinding of the material prior to extrusion contributes to a more uniform product upon extrusion. That is, by mechanically grinding the material and extruding the ground material, the final extrudate used to the form the seal possesses more a uniform composition. This results in a final seal that has more consistent properties throughout the seal and minimizes the presence of “fault” points in the seal. The final seal produced in this manner is more likely to exhibit consistent sealing properties and have an extended useable life as compared to non-ground, non-extruded thermoset rubber or TPE-containing seals.

In processes comprising multiple extrusion steps, the material comprising a thermoset rubber or TPE may be ground prior to each extrusion step or only after certain extrusion steps. For example, a three-extrusion preparation process may comprise the following steps: grinding-extrusion-grinding-extrusion-grinding-extrusion; extrusion-grinding-extrusion-grinding-extrusion; extrusion-extrusion-grinding-extrusion; or extrusion-grinding-extrusion-extrusion.

For example, in one embodiment, a TPE material is passed through an extrusion device to produce a first extruded TPE. The first extruded TPE is then ground by a mechanical grinding mechanism and passed through the extrusion device a second time to produce a second extruded TPE. The second extruded TPE is then ground by a mechanical grinding mechanism and passed through the extrusion device a third time to produce a third extruded material, which may be used in forming the seal. In another embodiment, a TPE material is passed through an extrusion device to produce a first extruded TPE. The first extruded TPE is then ground by a mechanical grinding mechanism and passed through the extrusion device a second time to produce a second extruded TPE, which may be used in forming the seal.

In some embodiment, the extrusion device(s) may be different. For example, in one embodiment, a TPE material is passed through a first extrusion device to produce a first extruded TPE. The first extruded TPE is then ground by a mechanical grinding mechanism and passed through a second extrusion device to produce a second extruded TPE. The second extruded TPE is then ground by a mechanical grinding mechanism and passed through a third extrusion device to produce a third extruded material, which may be used in forming the seal.

The one or more mechanical grinding steps may be accomplished by any conventional mechanical grinding mechanism. For example, the mechanical grinding mechanism may be selected from the group consisting of a granulator, hammer mill, cryogenic attrition mill, and roll mill. In certain embodiment, the material is mechanically ground by a process comprising granulation.

Certain processes for preparing a seal from the TPE material (e.g., injection molding) may produce regrind material as a waste product of the process. Regrind material is generally understood to represent a material that has been processed at least once before. It is important to the economics of the process to determine a suitable use for this waste regrind material. However, previous attempts to incorporate regrind material into the material used to form the seal have been found to contribute to an undesirable increase in the gas permeability of the final seal. A solution to this problem has been discovered by subjecting the TPE material to various extrusion and/or grinding steps prior to combining this processed TPE material with a portion of the regrind material. By subjecting the TPE material to, for example, three grinding/extrusion steps prior to combination with the regrind material, the regrind material may be incorporated into the process while still forming a seal having a commercially acceptable gas permeability.

For example, in one exemplary embodiment, the process of preparing the material for formation of a seal comprises passed a TPE material through an extrusion device to produce a first extruded material, passing the first extruded material through the extrusion device a second time to produce a second extruded material, passing the second extruded material through the extrusion device a third time to produce a third extruded material, and combining the third extruded material with a regrind material. The combined material is then formed into a seal (e.g., by injection molding).

In another embodiment, the process of preparing the material for formation of a seal comprises passing a TPE material through a first extrusion device to produce a first extruded TPE. The first extruded TPE is then ground by a mechanical grinding mechanism and passed through a second extrusion device to produce a second extruded TPE. The second extruded TPE is then ground by a mechanical grinding mechanism and passed through a third extrusion device to produce a third extruded material. The third extruded material is combined with a regrind material and then formed into a seal (e.g., by injection molding).

In embodiments wherein the TPE material or extruded TPE material is combined with a regrind material prior to forming a seal (e.g., by injection molding), it may be desirable to use a particular concentration of regrind material. For example, in certain embodiments, about 10% or more, about 20% or more, about 30% or more, about 40% or more, about 50% or more, about 60% or more, about 70% or more, about 80% or more, about 90% or more, about 95% or more, or about 99% or more of the combined material prior to forming the seal is regrind material. In some embodiments, from about 10% to about 99%, from about 20% to about 90%, from about 30% to about 90%, from about 40% to about 85%, from about 50% to about 85%, from about 60% to about 80%, from about 70% to about 80%, or from about 75% to about 80% of the combined material prior to forming the seal is regrind material.

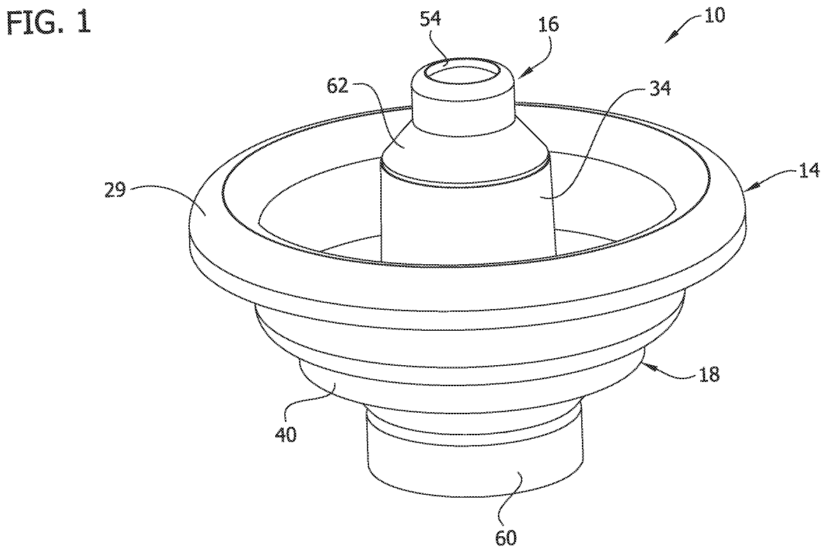

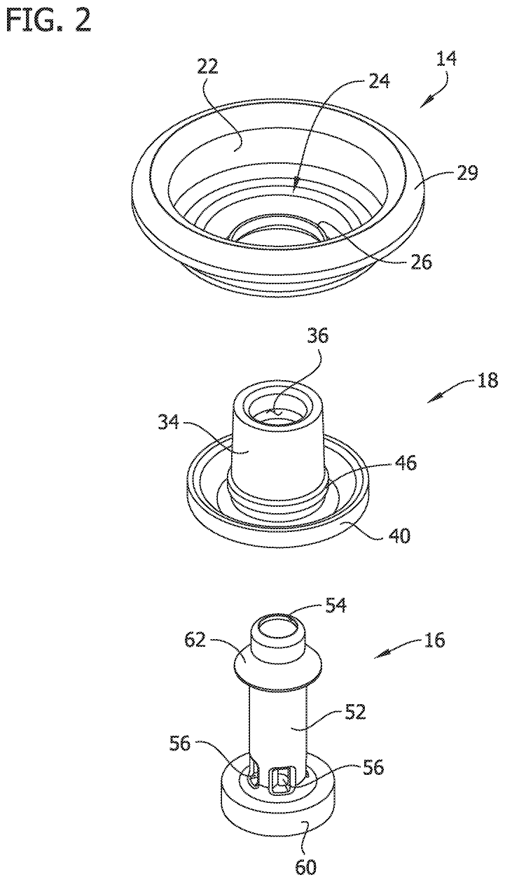

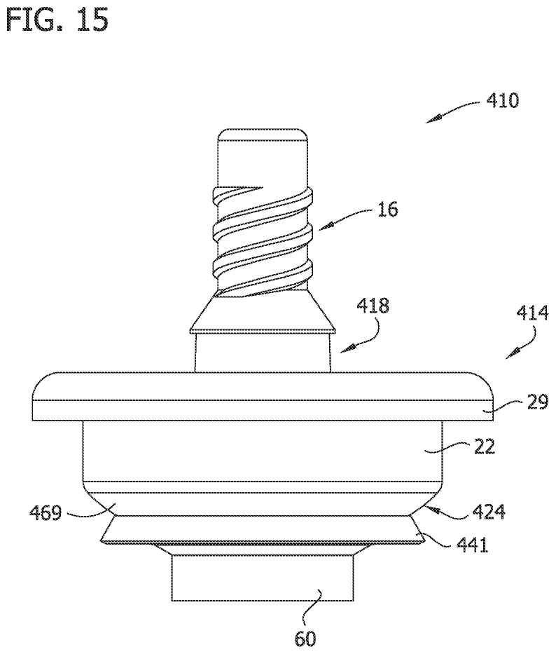

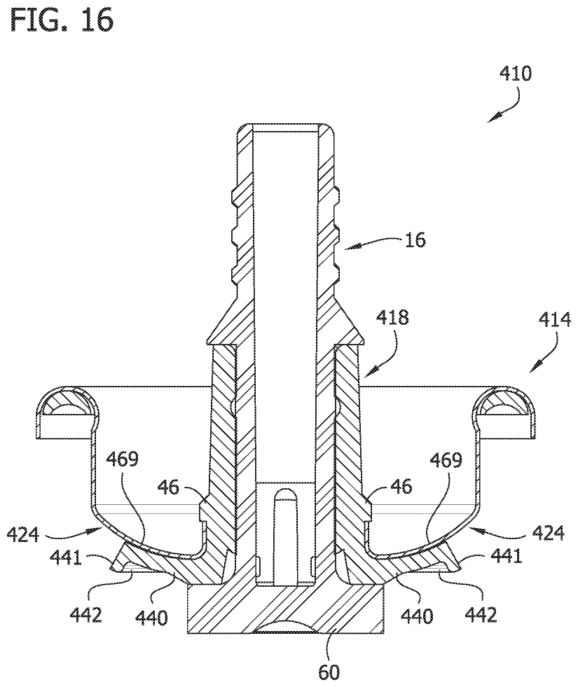

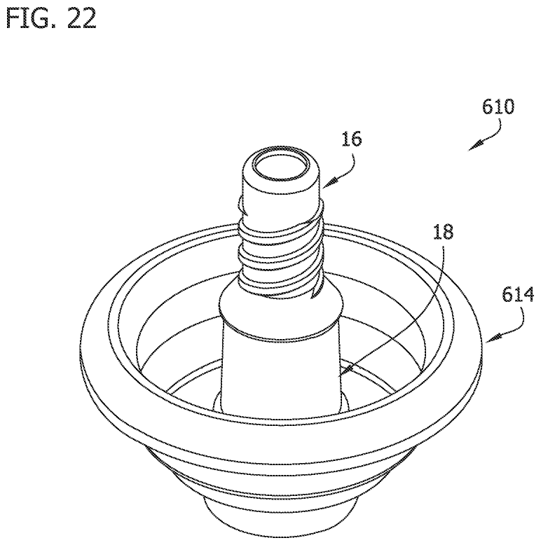

Set forth below and shown in FIGS. 1-28 are exemplary embodiments of a valve, seal, container configuration. However, none of the below or illustrated configurations should be construed as limiting the application or configuration in which the seal of the present disclosure may be used.

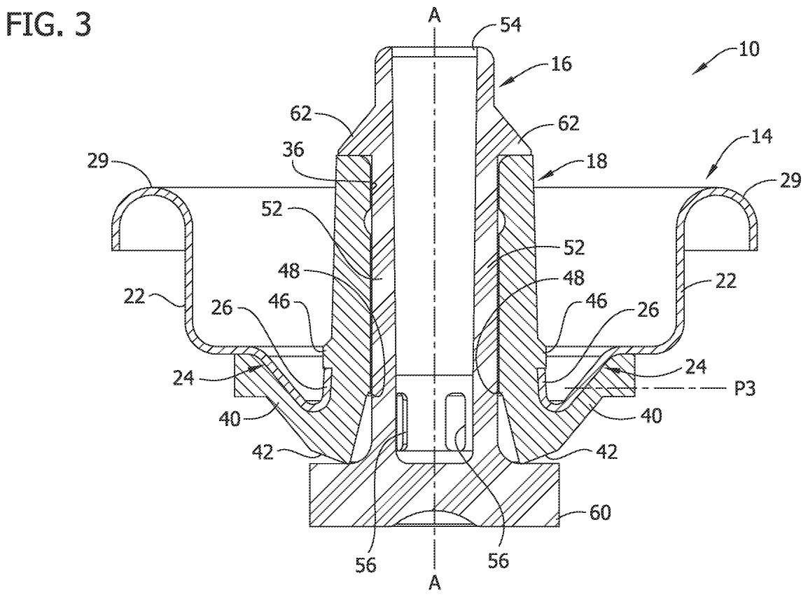

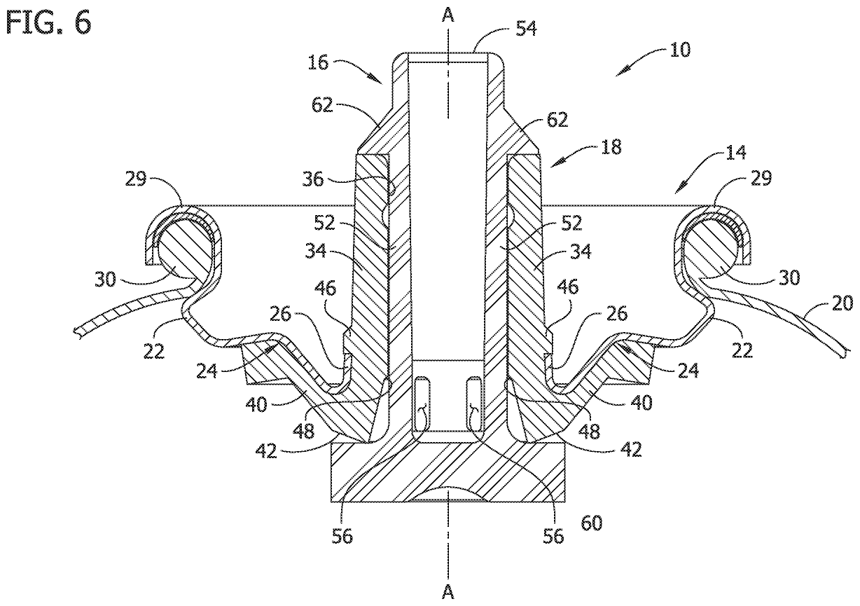

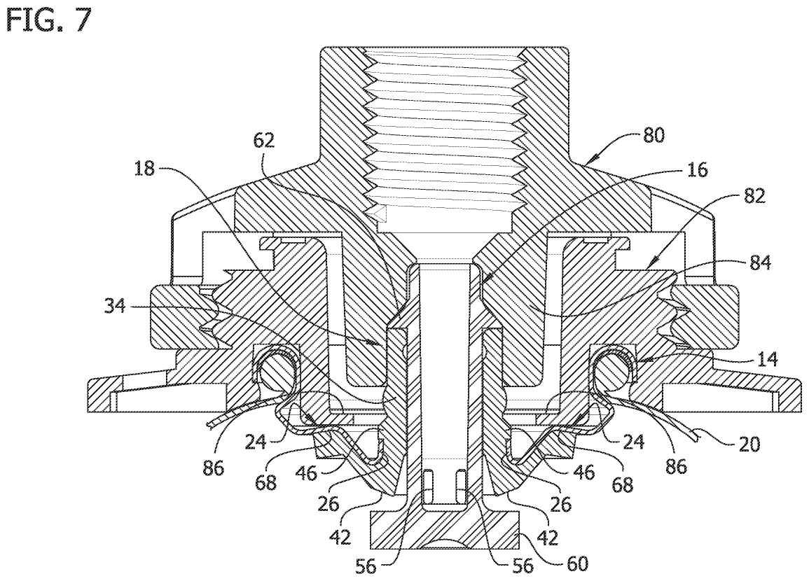

Referring to FIGS. 1-3, a valve for dispensing a flowable product (e.g., a chemical product or food product) from a container is generally indicated at reference numeral 10. The valve 10 comprises a mounting cup, generally indicated at 14; a stem, generally indicated at 16; and a seal (e.g., a grommet), generally indicated at 18, attached to the stem and disposed between and interconnecting the stem and the mounting cup. As shown in FIGS. 6 and 7, the illustrated valve 10 is suitable for attachment to a pressurized container 20 (e.g., an aerosol container), or other container, for dispensing flowable product contained within the container. In FIGS. 1 and 3, the valve 10 is shown in its pre-attached configuration, meaning that the valve is assembled but is not attached to a pressurized container. In FIG. 6 the valve 10 is shown in its attached, closed configuration, meaning that the valve is attached to the pressurized container 20 but the valve is closed (e.g., non-actuated). In FIG. 7 the valve 10 is shown in its attached, open configuration, meaning that the valve is attached to the pressurized container 20 and the valve has been opened (e.g., actuated), such as by a dispensing gun as shown. The orientation of the valve 10 in the drawings provides the point of reference for the terms defining relative locations and positions of structures and components of the valve, including but not limited to the terms “upper,” “lower,” “top,” and “bottom,” “upward,” and “downward,” as used throughout the present disclosure.

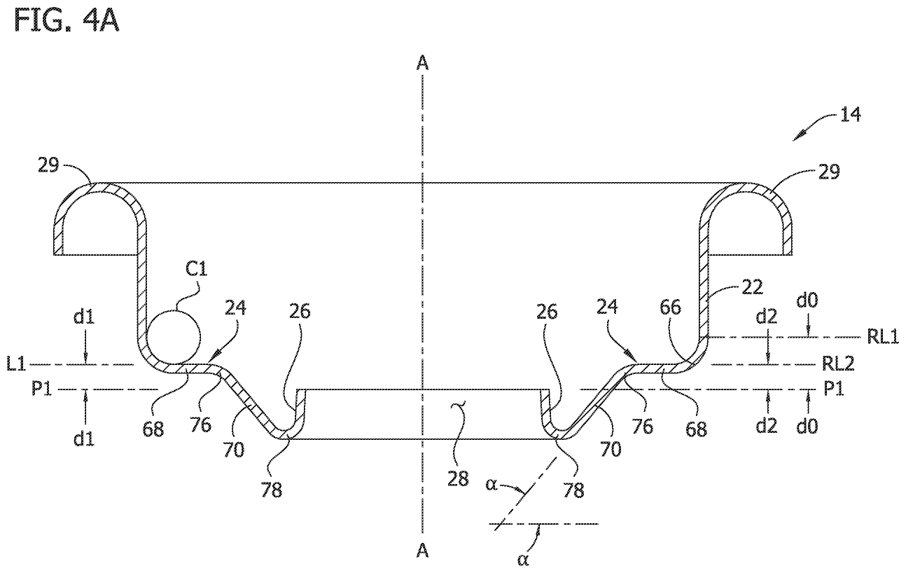

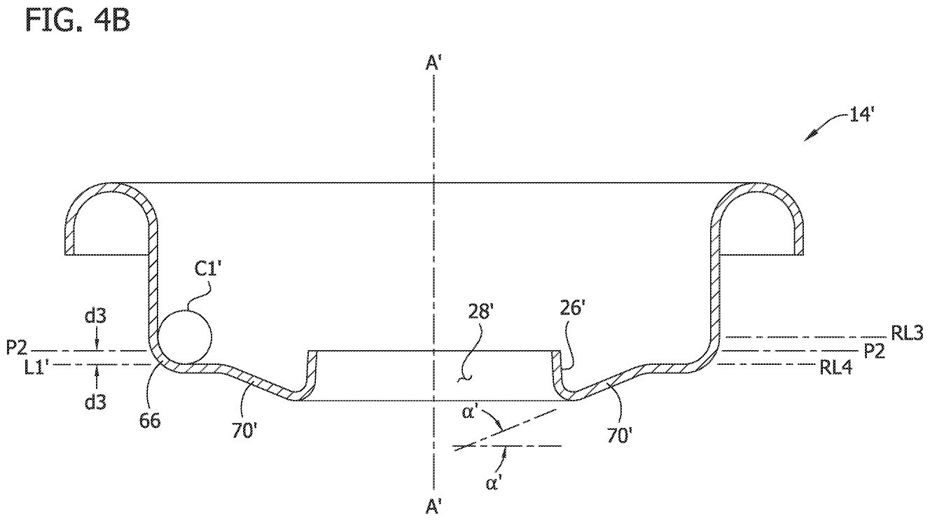

Referring to FIGS. 3 and 4A, the mounting cup 14, which may be formed from a piece of metal (e.g., tin plate steel, stainless steel or aluminum), has a generally cylindrical sidewall 22 defining an axis A of the mounting cup 14. In these figures, substantially an entirety of the sidewall 22 is generally parallel to the axis A of the mounting cup 14 when the valve is in its pre-attached configuration, as shown in FIG. 3, though in other configurations the sidewall may be tapered. When the valve 10 is attached to the container 20 (FIG. 6), a portion of the sidewall 22 bulges radially outward relative to the axis A to secure the valve to the container. The mounting cup 14 further includes a bottom wall, generally indicated at 24, extending radially inward from adjacent a lower end of the sidewall 22. A central portion 26 of the bottom wall 24 defines a cylindrical opening 28, also known as a pierce hole, through which the seal 18 and the stem 16 extend. In these figures, the central portion 26 of the bottom wall 24 extends upward to define a collar or ferrule surrounding the seal 18. The opening 28 has an axial length extending between open upper and lower ends of the collar or ferrule. In other configurations, the central portion 26 may not extend upward to define a collar or ferrule. Instead, the central portion 26 may be substantially planar and the opening 28 may extend therethrough and have an axial length corresponding to the thickness of the central portion. The configurations of the bottom wall 24 and the central portion 26 are explained in more detail below. The mounting cup 14 is configured for reception into an opening of the container 20, such as an opening in a top of the container 20 (as shown in FIG. 6) or a bottom of the container, and an upper curled lip 29 at an upper end of the sidewall 22 mates with the bead (curl) 30 of the container. The valve 10 is then secured to the container by crimping (clinching), for example.

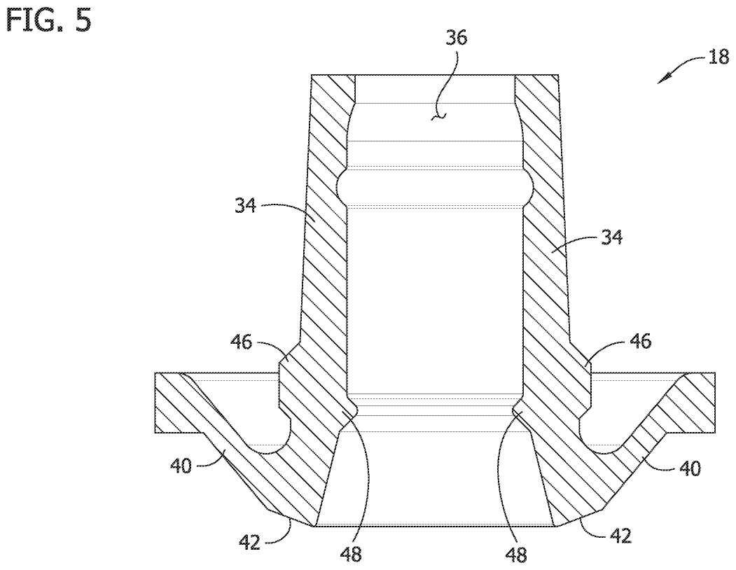

Referring to FIGS. 3 and 5, the seal 18 comprises an elongate neck portion 34 defining a longitudinal lumen 36 through which the stem 16 is received, as explained below. The lumen 36 is generally coaxial with the axis A of the mounting cup 14. A lower portion of the seal 18 underlies the bottom wall 24 of the mounting cup 14 and includes an annular flange portion 40 and seat portion 42 at a lower end of the seal defining a seat for the valve stem 16. As explained in more detail below, the annular flange portion 40 is normally pressed against the bottom wall 24 of the mounting cup 14 to form a leak proof seal therebetween when the valve 10 is secured to the container 20 (FIG. 6). An external seal bead 46 extends radially outward from the neck portion 34 of the seal 18. In one configuration, at least one internal seal bead 48 may extend inward from an inner surface of the neck portion 34. The external, annular seal bead 46 engages an upper peripheral edge of the central portion 26 of the mounting cup 14 to secure the seal 18 to the mounting cup. The internal seal bead 48, when included, presses against the stem 16 to form a seal therebetween, otherwise the seal may be obtained by an interference fit between the inner wall of lumen 36 and the stem 16. The seal 18 may comprise a thermoset rubber (e.g., vulcanized rubber, such as vulcanized neoprene rubber) or thermoplastic elastomer (e.g., thermoplastic polyurethane) as detailed above.

The stem 16 comprises an elongate tubular stem body 52 with an outlet 54 and inlet(s) 56 at the upper and lower ends thereof, respectively, and a disc 60 (or button) at the lower end of the stem body. The stem body 52 fits snugly within the longitudinal lumen 36 defined by the seal 18 and engages the internal seal bead 48, when included in the design, to form a leak proof seal therebetween. An upper portion of the stem body 52 is exposed and extends through an open upper end of the seal 18. In this figure, the upper portion of the stem body 52 includes an annular shoulder 62 extending laterally outward from the stem body and overlying and engaging the upper end of the seal 18. At the lower end of the stem 16, the disc 60 seats against the seat portion 42 of the seal 18 to form a leak proof seal therebetween when the valve 10 is closed (e.g., in a non-actuated configuration). In other configurations, the upper portion of the stem body 52, above annular shoulder 62, may include a thread (or other connector or connecting structure) for connecting the stem 16 to an actuator or other device. As an example, the upper portion of the stem body 52 may include a thread onto which an actuation device may be attached when the valve 10 is used as a tilt valve, as generally known in the art. In yet other configurations, the valve may be used without any additional actuator and may include a component for profiling or shaping the dispensed product.

As shown in FIG. 7, the disc 60 of the stem 16 is movable away from the seat portion 42 of the seal 18 to open the valve (e.g., move the valve to an actuated configuration) to allow flowable product in the container 20, via pressure in the container, to flow between the disc and the seat portion and into the inlet(s) 56 of the stem 16. As disclosed above, the valve 10 may function as a “vertically actuated” valve, or alternatively, as a “tilt” valve, depending on the actuator used to operate the valve. For example, when used as a vertically actuated valve, an axial force is applied to the stem 16 (e.g., the shoulder 62 of the stem) to unseat the disc 60 from the seat portion 42 of the seal 18, as shown in FIG. 7 and described in more detail below. In another example, when used as a tilt valve (not shown), a force is applied to the side of stem 16 to rotate or pivot the stem and unseat the disc 60 from the seat portion 42, as is generally known in the art.

Referring to FIG. 4A, an annular side-to-bottom transition portion, generally indicated at 66, of the mounting cup 14 is disposed between the lower end of the sidewall 22 and the bottom wall 24 thereof. The side-to-bottom transition portion 66 curves inward (e.g., is radiused) from the lower end of the sidewall 22 to the bottom wall 24. The side-to-bottom transition portion 66 has an upper boundary (or extent) defined by an upper, annular radius line defining upper radius line plane RL1 transverse to the axis A, and a lower boundary (or extent) defined by a lower, annular radius line RL2 defining lower radius plane RL2 transverse to the axis A. The bottom wall 24 has an annular outer radial portion 68 extending radially inward from the side-to-bottom transition portion 66, and an annular inner radial portion 70 extending radially inward from adjacent an inner radial edge of the outer radial portion toward the axis A of the mounting cup and the central portion 26. As illustrated, the outer radial portion 68 is generally flat and extends generally orthogonal to the axis A of the mounting cup 14 when the valve 10 is in its pre-attached configuration (FIGS. 3 and 4A). When the valve 10 is attached to the container, such as shown in FIG. 6, the outer radial portion 68 of bottom wall 24 may not remain in a flat position orthogonal to the axis A of the mounting cup 14 but may extend upward or downward from the sidewall 22 at an angle greater than or less than 90 degrees relative to the axis A of the mounting cup. The outer radial portion may be of other configurations and orientations both in its pre-attached and attached configurations.

In some configurations, the inner radial portion 70 extends downward at an angle α relative to a plane extending orthogonal to the axis A of the mounting cup 14. For example, this angle α may measure from greater than 0 degrees (e.g., about 5 degrees) to about 90 degrees, or may be an acute angle measuring from about 25 degrees to about 50 degrees, and in one example, about 45 degrees. In another configuration, the inner radial portion 70 may extend at an angle measuring 0 degrees. An annular first bottom transition portion 76 is disposed between and interconnects the inner and outer radial portions 68, 70, respectively. The first bottom transition portion 76 curves downward (e.g., has a concave radius when viewed from the bottom) from the outer radial portion 68 to the inner radial portion 70. An annular second bottom transition portion 78 is disposed between and interconnects an inner radial edge of the inner radial portion 70 and the central portion 26. The second bottom transition portion 78 curves upward (e.g., has a convex radius when viewed from the bottom).

Referring still to FIG. 4A, the upper end of the central portion 26 defining the opening 28 (e.g., the end of the central portion that is engaged by the external seal bead 46 lies in a plane P1) is at (e.g., coplanar with) or below (e.g., entirely below) the upper radius line plane RL1. In one configuration, the upper end of the central portion 26 defining the opening 28 (e.g., the end of the central portion that is engaged by the external seal bead 46 lies in a plane P1) is at (e.g., coplanar with) or below (e.g., entirely below) the lower radius line plane RL2. In one configuration, the upper end of the central portion 26 defining the opening 28 (e.g., the end of the central portion that is engaged by the external seal bead 46 lies in a plane P1) is at (e.g., coplanar with) or below (e.g., entirely below) an imaginary line L1 perpendicular to the central axis A and tangent to a lower portion of an imaginary circle C1 defined by the radius of the annular sidewall-bottom transition portion 66. In FIG. 4A, the imaginary line L1 and the lower radius line plane RL2 are coplanar, although in other configurations, the imaginary line L1 and the lower radius line RL2 may not be coplanar (i.e., may be spaced apart along the axis A). In FIG. 4A, the plane P1 is below (e.g., entirely below) the line L1 and lower radius line plane RL2. In one configuration, a distance do between the upper radius line plane RL1 and the plane P1 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In one configuration, a distance d1 between the imaginary line L1 and the plane P1 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In one configuration, a distance d2 between the lower radius line plane RL2 and the plane P1 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

As shown in FIG. 4B and indicated generally at reference numeral 14′, the upper end of the central portion 26′ defining the opening 28′ (e.g., the end of the central portion that is engaged by the external seal bead 46 lies in a plane P2) is slightly above the lower radius line plane RL4 and/or the line L1′ perpendicular to the central axis A′ and tangent to the lower portion of the imaginary circle C1′ defined by the radius of the annular sidewall-bottom transition portion 66. In one configuration, a distance d3 between the imaginary line L1′ (and the lower radius line plane RL4) and the plane P2 in which the upper end of the central portion 26′ lies may be from about 0.000 in (0.000 mm) to about 0.040 in (1.016 mm) (e.g., no greater than 0.040 in). In this configuration, the plane P2 is below (e.g., entirely below) the upper radius line plane RL3. Accordingly, the plane P2 is intermediate the upper radius line plane RL3 and the imaginary line L1′ (and the lower radius line plane RL4) along the axis A. In this configuration, the inner radial portion 70′ extends downward at an angle α′ relative to a plane extending orthogonal to the axis A′ of the mounting cup 14′ that is less than the angle α of the first mounting cup 14.

In FIG. 7 a gun basket, generally indicated at 80, of a dispensing gun is attached (e.g., threaded onto) a gun collar (broadly, a connector), generally indicated at 82, which is attached to the valve 10 after the valve is attached to the container 20. As the gun basket 80 is threaded onto the gun collar 82, the upper portion of the stem 16 and the neck portion 34 of the seal 18 enter a hub 84 of the gun basket. An internal shoulder of the hub engages the shoulder 62 of the stem 16 to drive axial movement of the stem relative to the seal 18 and unseat the stem disc 60 from the seat portion 42 of the seal. As the stem 16 moves downward, the neck portion 34 of the seal 18 compresses between the shoulder 62 of the stem and the upper peripheral edge of the central portion 26, and the neck portion 34 of the seal bulges outward inside the hub 84 to create a leak proof seal therein. Because the upper end of the central portion 26 is at or below at least a junction of the sidewall 22 and the annular sidewall-bottom transition portion 66, such as at or below (e.g., below) an entirety of the outer radial portion 68 of the bottom wall 24 as can be seen from FIG. 7, if the gun basket hub 84 is of a design that allows it to approach the bottom wall 24 when the gun collar 82 is threaded fully into the gun basket 80, the gun collar 82 will “bottom out” in the gun basket 80 before the gun basket hub 82 engages the external seal bead 46. This inhibits the external sealing bead 46 from being pinched between the hub 84 and the upper peripheral edge of the central portion 26, thereby inhibiting the external seal bead from shearing off.

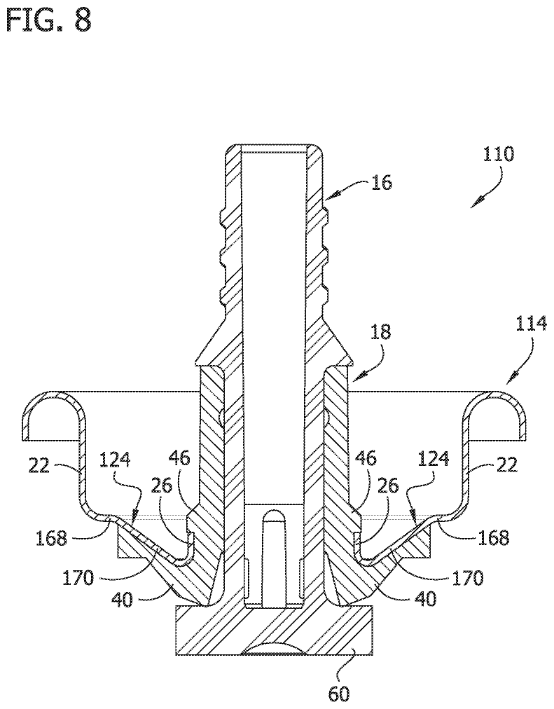

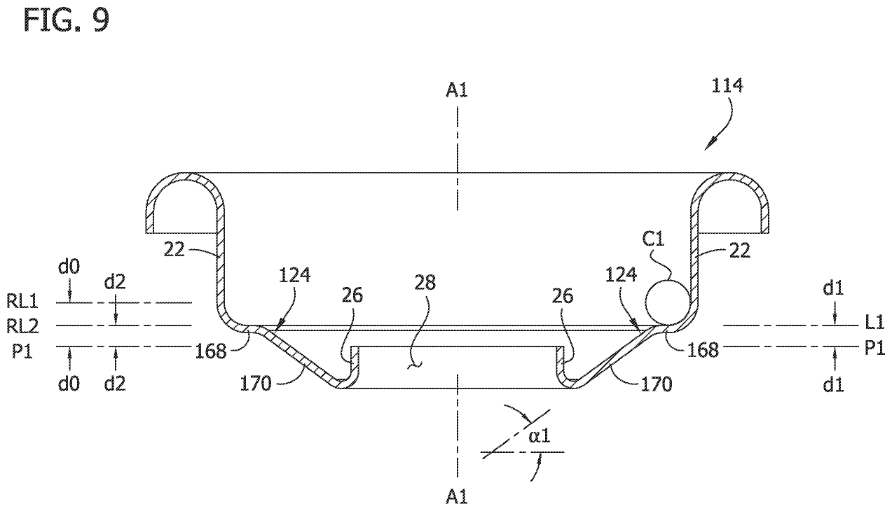

Referring to FIGS. 8 and 9, another configuration of a valve is generally indicated at reference numeral 110. This valve 110 is similar to the first valve 10, with differences between the valves being disclosed below. Identical components and structures are indicated by corresponding reference numerals, and similar, but not identical, components and structures are indicated by corresponding reference numerals plus 100. Unless otherwise indicated, the teachings and disclosure set forth above with respect to the first valve 10 apply equally to the valve 110. The main differences between the valve 110 and the first valve 10 is the respective radial dimensions of the outer and inner radial portions 168, 170 of the bottom wall 124 of the mounting cup 114 and the relationship between the flanges 40 of the seal 18 and the mounting cup. In particular, the radial dimension of the outer radial portion 168 is shortened and the radial dimension of the inner radial portion 170 is extended. As such, the flanges 40 of the seal 18 extend along the inner radial portion 170 but do not extend to the outer radial portion 168. Moreover, because the radial dimension of the inner radial portion 170 is extended, the downward slope of the inner radial portion may be less than the slope of the inner radial portion 70 of the first valve. In other words, the inner radial portion 170 may extend downward at an angle α1 relative to a plane extending orthogonal to the axis A1 of the mounting cup 114 that is less than the angle α of the first valve 10.

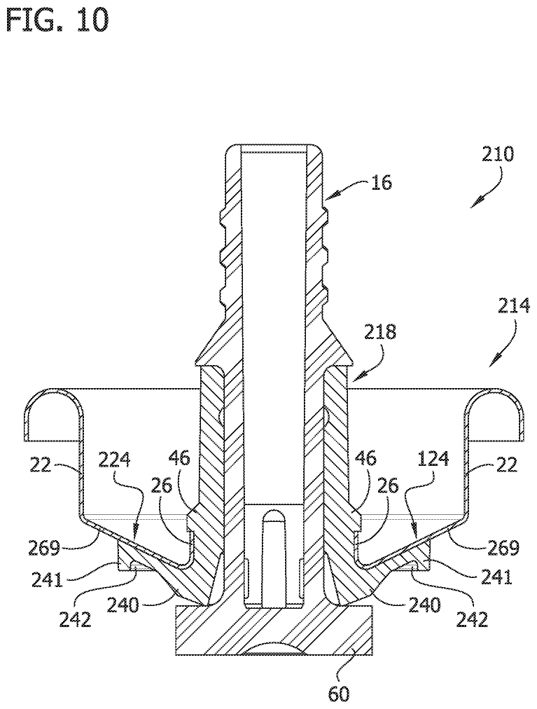

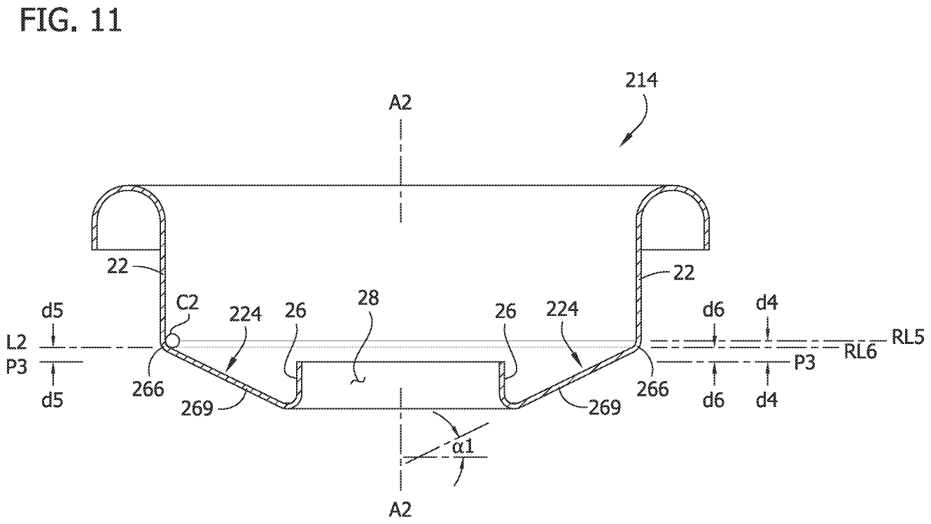

Referring to FIGS. 10 and 11, a valve is generally indicated at reference numeral 210. The valve 210 is similar to the first valve 10. Identical components and structures are indicated by corresponding reference numerals, and similar, but not identical components and structures, are indicated by corresponding reference numerals plus 200. Unless otherwise indicated, the teachings and disclosure set forth above with respect to the first valve 10 apply equally to the valve 210. The seal 218 is similar to seal 18, except that the seal 218 includes a depending terminal flange 241 at the outer end of the flange 240. The terminal flange 241 is generally annular shaped and extends around the flange 240. The terminal flange 241 extends generally downward from the flange 240 to define an annular groove 242 of the seal. In use, pressure within the can is exerted against the flange 240 within the annular groove 242 to facilitate sealing of the flange against the radial portion 269 of the bottom wall 224.

Referring to FIG. 11, an annular side-to-bottom transition portion, generally indicated at 266, of the mounting cup 214 is disposed between the lower end of the sidewall 22 and the bottom wall 224 thereof. The side-to-bottom transition portion 266 curves inward (e.g., is radiused) from the lower end of the sidewall 22 to the bottom wall 224. The side-to-bottom transition portion 266 has an upper boundary (or extent) defined by an upper, annular radius line defining upper radius line plane RL5 transverse to the axis A2, and a lower boundary (or extent) defined by a lower, annular radius line RL6 defining lower radius plane RL6 transverse to the axis A2. The bottom wall 224 has an annular radial portion 269 extending radially inward from the side-to-bottom transition portion 266 to the central portion 26 of the bottom wall. In this configuration, the radial portion 269 extends downward at a constant angle α2 (e.g., a constant slope) relative to a plane extending orthogonal to the axis A2 of the mounting cup 214 when the valve 210 is in its pre-attached configuration. For example, this angle α2 may measure from about 5 degrees to about 90 degrees, or may be an acute angle measuring from about 25 degrees to about 50 degrees, and in one example, about 30 degrees. When the valve 210 is attached to the container, the radial portion 269 of bottom wall 224 may or may not remain at this pre-attached angle α2. For example, the radial portion 269 may extend upward or downward from the sidewall 22 at an angle greater than or less than its pre-attached angle α2. The radial portion 269 may be of other configurations and orientations both in its pre-attached and attached configurations.

Referring still to FIG. 11, the upper end of the central portion 26 defining the opening 28 (e.g., the end of the central portion that is engaged by the external seal bead 46 lies in a plane P3) is at (e.g., coplanar with) or below (e.g., entirely below) the upper radius line plane RL5. In one configuration, the upper end of the central portion 26 defining the opening 28 (e.g., the end of the central portion that is engaged by the external seal bead 46 lies in a plane P3) is at (e.g., coplanar with) or below (e.g., entirely below) the lower radius line plane RL6. In one configuration, the upper end of the central portion 26 defining the opening 28 (e.g., the end of the central portion that is engaged by the external seal bead 46 lies in a plane P3) is at (e.g., coplanar with) or below (e.g., entirely below) an imaginary line L2 perpendicular to the central axis A2 and tangent to a lower portion of an imaginary circle C2 defined by the radius of the annular sidewall-bottom transition portion 266. In FIG. 11, the imaginary line L2 and the lower radius line plane RL6 are coplanar, although in other configurations, the imaginary line L2 and the lower radius line RL6 may not be coplanar (i.e., spaced apart along the axis A2). In FIG. 11, the plane P3 is below (e.g., entirely below) the line L2 and lower radius line plane RL6.

In one configuration, a distance d4 between the upper radius line plane RL5 and the plane P2 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In another configuration, a distance d5 between the imaginary line L2 and the plane P3 may be from about 0.0 mm to about 25.0 mm, or from about 0.25 mm to about 10.0 mm, or from about 0.1 mm to about 2.5 mm, or from about 0.25 mm to about 2.0 mm, or about 1.0 mm, or about 0.50 mm. In still a further configuration, a distance d6 between the lower radius line plane RL6 and the plane P2 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

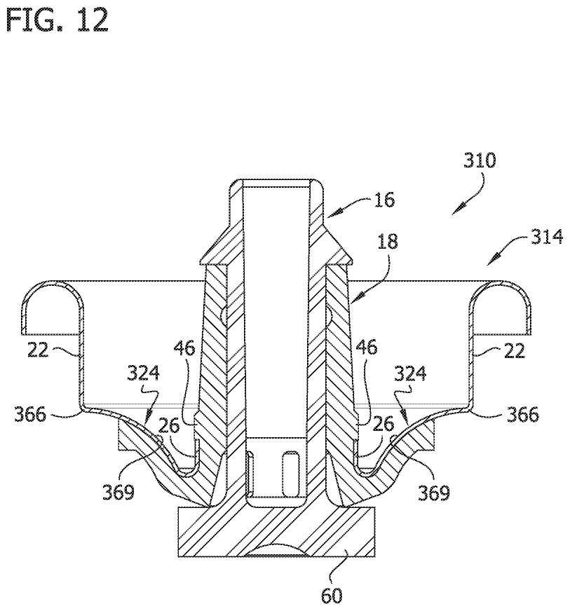

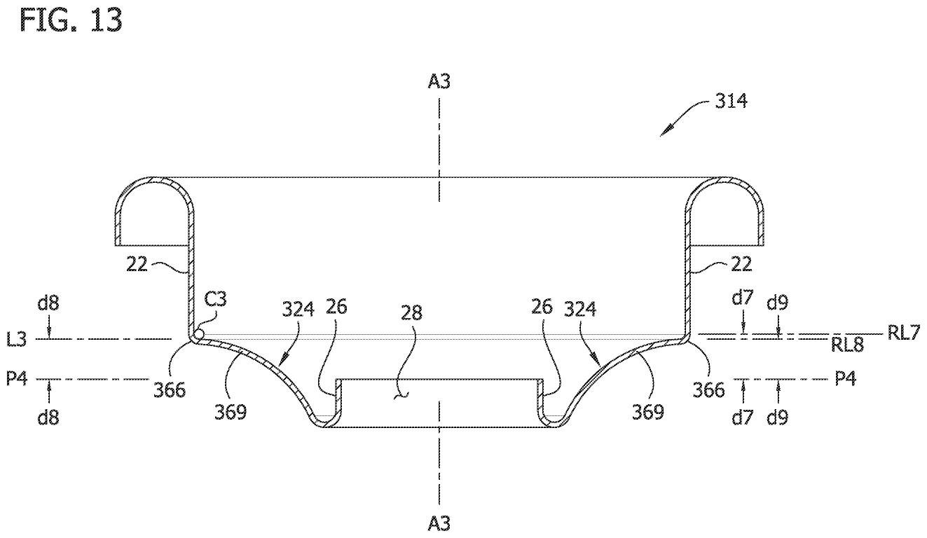

Referring to FIGS. 12 and 13, a valve is generally indicated at reference numeral 310. This valve 310 is similar to the third valve 210, with differences between the valves being disclosed below. Identical components and structures are indicated by corresponding reference numerals, and similar, but not identical, components and structures are indicated by corresponding reference numerals plus 100. Unless otherwise indicated, the teachings and disclosure set forth above with respect to the third valve 210 apply equally to the valve 310. The main differences between the valve 310 and the third valve 210 is the radial portion 369 of the bottom wall 324 is arcuate shaped and curves upward along its length (i.e., is concave when viewed from bottom), unlike the radial portion 269 of the bottom wall 224 of the third valve 210 which has a substantially constant slope or angle extending downward. Another difference is that an imaginary circle C3 defined by the radius of the annular sidewall-bottom transition portion 366 is smaller than the imaginary circle C2.

Referring still to FIG. 13, the upper end of the central portion 26 defining the opening 28 (e.g., the end of the central portion that is engaged by the external seal bead 46 lies in a plane P4) is at (e.g., coplanar with) or below (e.g., entirely below) the upper radius line plane RL7. In one configuration, the upper end of the central portion 26 defining the opening 28 (e.g., the end of the central portion that is engaged by the external seal bead 46 lies in a plane P4) is at (e.g., coplanar with) or below (e.g., entirely below) the lower radius line plane RL8. In another configuration, the upper end of the central portion 26 defining the opening 28 (e.g., the end of the central portion that is engaged by the external seal bead 46 lies in a plane P4) is at (e.g., coplanar with) or below (e.g., entirely below) an imaginary line L3 perpendicular to the central axis A3 and tangent to a lower portion of an imaginary circle C3 defined by the radius of the annular sidewall-bottom transition portion 366. In FIG. 13, the imaginary line L3 and the lower radius line plane RL8 are coplanar, although in other configurations, the imaginary line L3 and the lower radius line RL8 may not be coplanar (i.e., spaced apart along the axis A3). In FIG. 13, the plane P4 is below (e.g., entirely below) the line L3 and lower radius line plane RL8.

In one configuration, a distance d7 between the upper radius line plane RL7 and the plane P4 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In another configuration, a distance d8 between the imaginary line L3 and the plane P4 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In still another configuration, a distance d9 between the lower radius line plane RL8 and the plane P4 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

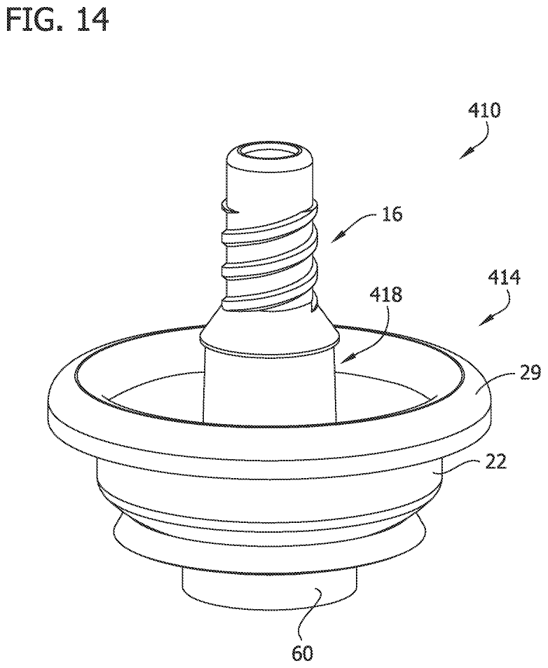

Referring to FIGS. 14-17, a valve is generally indicated at reference numeral 410. This valve 410 is similar to the third valve 210, with differences between the valves being disclosed below. Identical components and structures are indicated by corresponding reference numerals, and similar, but not identical, components and structures are indicated by corresponding reference numerals plus 200. Unless otherwise indicated, the teachings and disclosure set forth above with respect to the third valve 210 apply equally to the valve 410. The seal 418 is similar to seal 218, except that the terminal flange 441 at the outer end of the flange 440 flares outward. The terminal flange 441 is generally annular shaped and extends around the flange 440. The terminal flange 441 extends generally downward from the flange 240 and flares outward to define an annular groove 442 of the seal. In use, pressure within the can is exerted against the flange 440 within the annular groove 442 to facilitate sealing of the flange against the radial portion 469 of the bottom wall 424.

Another difference between the valve 410 and the third valve 210 is the radial portion 469 of the bottom wall 424 is arcuate shaped, extends downward and curves downward along its length (i.e., is convex or dome-shaped when viewed from bottom), unlike the radial portion 269 of the bottom wall 224 of the third valve 210 which has a substantially constant slope or angle extending downward. In one example, the bottom wall may have a radius of about 0.450 in (1.143 cm).

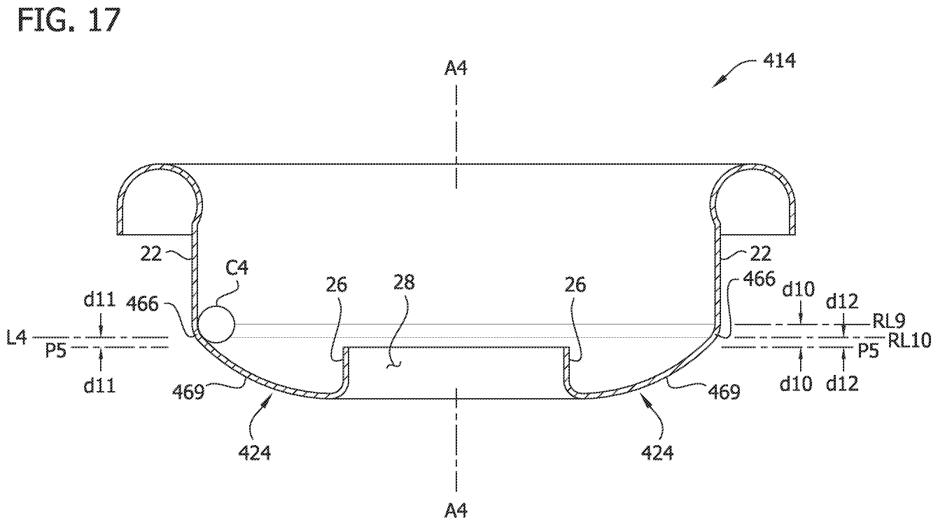

Referring still to FIG. 17, the upper end of the central portion 26 defining the opening 28 (e.g., the end of the central portion that is engaged by the external seal bead 46 lies in a plane P5) is at (e.g., coplanar with) or below (e.g., entirely below) the upper radius line plane RL9. In one configuration, the upper end of the central portion 26 defining the opening 28 (e.g., the end of the central portion that is engaged by the external seal bead 46 lies in a plane P5) is at (e.g., coplanar with) or below (e.g., entirely below) the lower radius line plane RL10. In another configuration, the upper end of the central portion 26 defining the opening 28 (e.g., the end of the central portion that is engaged by the external seal bead 46 lies in a plane P5) is at (e.g., coplanar with) or below (e.g., entirely below) an imaginary line L4 perpendicular to the central axis A4 and tangent to a lower portion of an imaginary circle C4 defined by the radius of the annular sidewall-bottom transition portion 466. In FIG. 17, the imaginary line L4 and the lower radius line plane RL10 are coplanar, although in other configurations, the imaginary line L4 and the lower radius line RL10 may not be coplanar (i.e., spaced apart along the axis A4). In FIG. 17, the plane P5 is below (e.g., entirely below) the line L4 and lower radius line plane RL10.

In one configuration, a distance d10 between the upper radius line plane RL9 and the plane P5 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In another configuration, a distance d11 between the imaginary line L4 and the plane P5 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In still another configuration, a distance d12 between the lower radius line plane RL10 and the plane P5 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

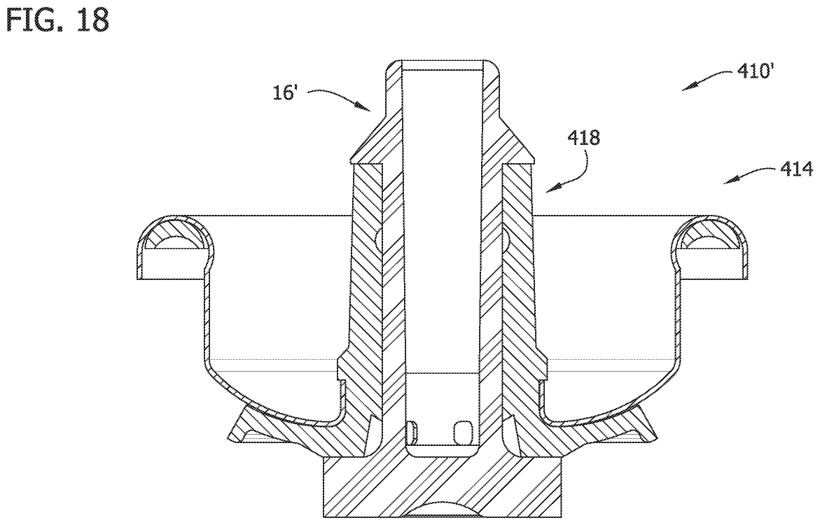

Referring to FIG. 18, another valve, generally indicated at reference 410′, is identical to the valve 410, except that the stem 16, which is a tilt stem, is replaced with a “vertically actuated” stem (or gun valve stem) 16′. All other components of the valve 410′ are identical to the corresponding components of the valve 410.

It is believed that each of the other valves (e.g., 110, 210, etc.) provide the same advantages as set forth above with respect to the first valve 10. Accordingly, the advantages set forth above with respect to the first valve 10 apply equally to the other valves.

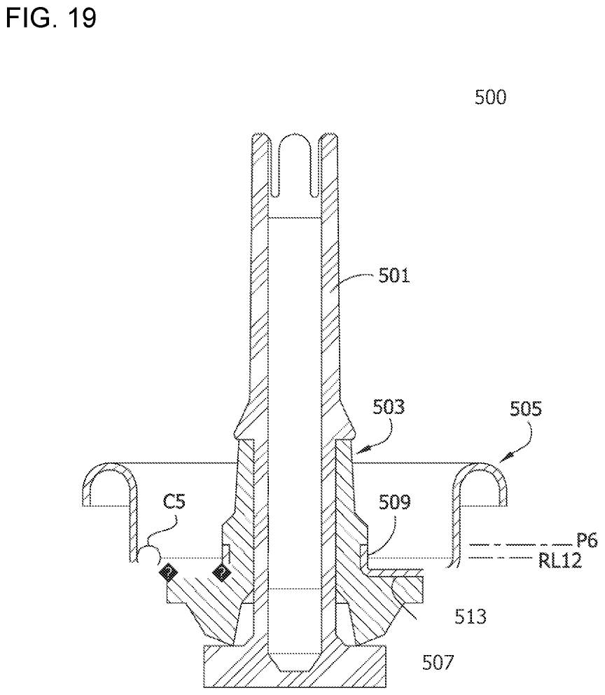

In addition, each of the valves provide the following advantages over a conventional valve. As shown in FIG. 19, a typical prior art valve is generally indicated at reference numeral 500. The prior valve is a tilt valve including a tilt stem 501, a seal 503, and a mounting cup 505. As was typical with this type of prior valve, the bottom wall 507 of the mounting cup defines a cylindrical opening 509, also known as a pierce hole, through which the seal 503 and the stem 501 extend, and the plane P6 in which the upper end of the pierce hole is disposed is above the lower radius line plane RL11 and an imaginary line L5 perpendicular to the central axis A5 and tangent to a lower portion of an imaginary circle C5 defined by the radius of the annular sidewall-bottom transition portion 513. The upper end of the pierce hole 509 is also disposed is above the upper radius line plane RL12 bounding the annular sidewall-bottom transition portion 513.

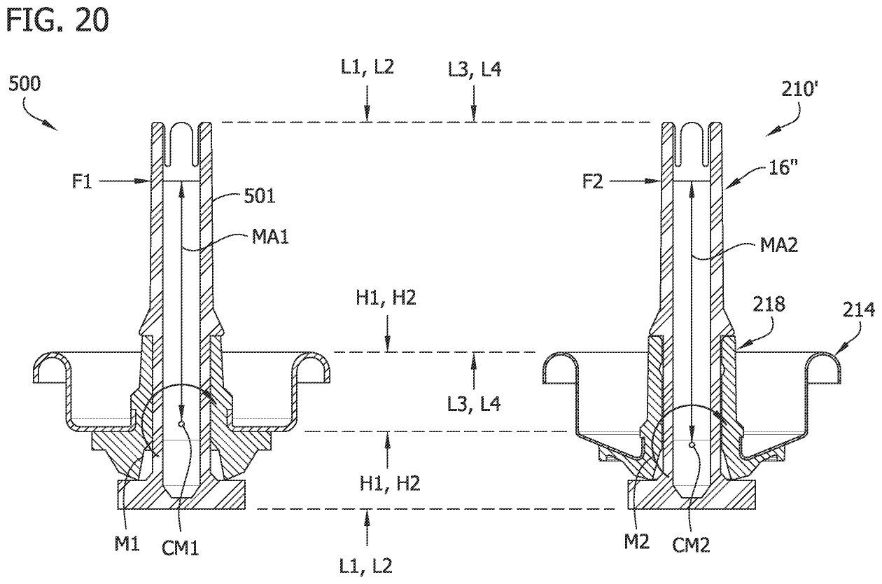

Referring to FIG. 20, a side-by-side comparison of the conventional valve 500 of FIG. 19 and a valve 210′ is illustrated. The valve 210′ includes the mounting cup 214 and seal 218 of the valve 210 of FIG. 10. A stem 16″ is different than the stem 16 of the valve 210. The stem 16″ is identical to the stem 501 of the conventional valve 500. The valve 210′ is shown for illustrative purposes with the understanding that each of the valves disclosed above herein provide the same advantage over the conventional valve 500, as set forth below. FIG. 20 illustrates the moment arms MA1, MA2, the moments M1, M2, and the moment centers, CM1, CM2 (or rotational or pivot axes) of the respective valves 500, 210′. As can be seen in FIG. 20, the moment arm MA2 of the valve 210′ is greater (i.e., longer) than the moment arm of the conventional valve 500. By having a greater moment arm MA2, the force F2 (i.e., tilt force) required to open the valve 210 and dispense product therefrom is less than the force F1 (i.e., tilt force) required to open the conventional valve 500 and dispense product therefrom. Table 1 (below) shows the force required to open the conventional valve to dispense a product. Table 2 (below) shows the force required to open the valves described herein to dispense a product.

TABLE 1
Conventional Valve of FIG. 19

| | Tilt Force | Deflection at |
|---|---|---|
| | (lbf) | Tilt Force (in) |
| Conventional Valve 1 | 5.15 | 0.23 |
| Conventional Valve 2 | 5.02 | 0.20 |
| Conventional Valve 3 | 5.26 | 0.22 |
| Conventional Valve 4 | 4.58 | 0.22 |
| Conventional Valve 5 | 4.09 | 0.20 |
| Conventional Valve 6 | 5.74 | 0.20 |
| Conventional Valve 7 | 6.01 | 0.27 |
| Conventional Valve | 5.89 | 0.28 |

TABLE 2
Valve of FIG. 20

| | Tilt Force | Deflection at |
|---|---|---|
| | (lbf) | Tilt Force (in) |
| Valve of FIG. 20 | 4.34 | 0.18 |
| Valve of FIG. 20 | 3.73 | 0.17 |
| Valve of FIG. 20 | 4.26 | 0.17 |
| Valve of FIG. 20 | 3.84 | 0.17 |
| Valve of FIG. 20 | 3.47 | 0.15 |

The valve 210′ has greater moment arm due to the fact that the moment center CM2 of the stem of the valve is “lower” than the moment center CM1 of the stem of the conventional valve, which is due to the pierce hole of the valve being “lower” than the pierce hole of the conventional valve. Thus, as can also be seen from FIG. 20, the lengths L1, L2 of the stems 501, 16″ of the respective conventional valve 500 and the valve 210′ are substantially equal (in fact, the stems are identical). Moreover, in one or more configurations, the distances L3, L4 that the stems 501, 16″ extend above the upper portion of the corresponding cup are also substantially equal. Moreover still, the partial heights H1, H2 of the respective mounting cups 505, 214 from the upper surfaces to the lower radius line planes RL12, RL6 are substantially equal. Accordingly, certain dimensions of the valves 500, 210′ are substantially the same so that the valve can be interchangeably used in place of the conventional valve without the need to change the designs of container (e.g., aerosol can) and/or packaging, such as lids and boxes.

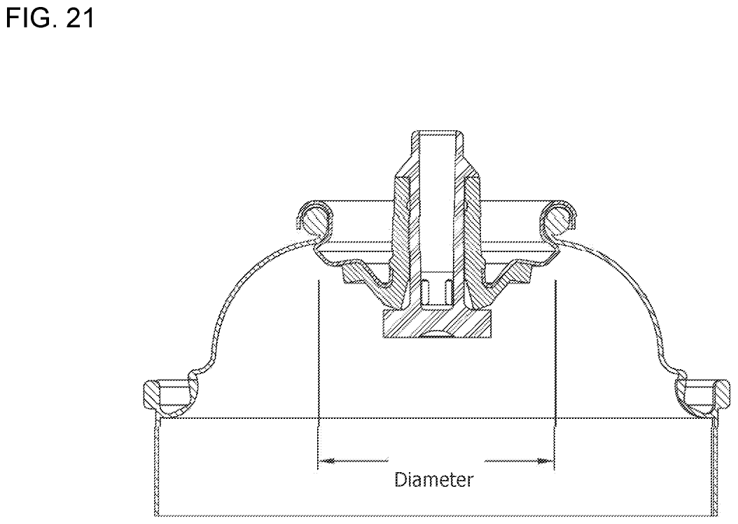

Another advantage of the valve configurations described above, particularly the valve 410 shown in FIG. 14, compared to the conventional valve 500 is the decrease in the amount of “rise” of the valve when crimping the valve to the container (e.g., aerosol can). Referring to FIG. 21, valves are typically crimped onto aerosol cans in order to create a seal between the can and the valve. During this crimping process the valve cup is deformed. This deformation of the valve cup causes the valve tip to change its position (generally known as “rise”). This can be an issue for valves used in packaging configurations that dock with the tip of the valve. One example of this is gun valves for one component polyurethane foam. Another example could be dispenser caps that connect with the tip of the valve.

As explained above, the valve tip position is affected by the crimp. As the dimensions of the crimp are varied the tip position generally varies as well. Crimp dimensions are generally measured in depth from the top of the cup to the centerline of the crimp and diameter of the crimp as shown in FIG. 21. A typical crimp dimension would be specified as 0.205 in×1.055 in (5.207 mm×26.797 mm), which would be a depth of 0.205 in (5.207 mm) and a diameter of 1.055 in (26.797 mm).

The valve 410, more particularly the mounting cup 414 of the valve, is less susceptible to variations in tip height caused by variation in crimp dimensions as compared to the conventional valve 500 of FIG. 19. That is, the variation in the tip position, after crimping, as a function of crimp depth and diameter is reduced as compared to the conventional valve 500 of FIG. 19. Table 3 includes data as to the tip position for various crimp dimensions for the conventional valve 500 and the valve 410 illustrated in FIG. 14.

TABLE 3
Variation in Tip Position at Various Crimp Dimensions (inches).

| Before Gassing | | | After Gassing | | | After Collar | | | |
|---|---|---|---|---|---|---|---|---|---|
| Chime to | Chime to | Cup to | Chime to | Chime to | Cup to | Chime to | Chime to | Collar to | Gun |
| Cup | Stem | Stem | Cup | Stem | Step | Stem | Collar | Stem | Opening |

Cup Crimps Depth .200 DIA. 1.045

| | | | | | | | | | | |
|---|---|---|---|---|---|---|---|---|---|---|
| 1 | 0.8365 | 1.1690 | 0.3320 | 0.8440 | 1.1970 | 0.3520 | 1.1970 | 1.1025 | −0.0555 | 0.0460 |
| 2 | 0.8415 | 1.1665 | 0.3250 | 0.8490 | 1.1970 | 0.3470 | 1.1945 | 1.1030 | −0.0550 | 0.0500 |
| 3 | 0.8370 | 1.1705 | 0.3220 | 0.8450 | 1.1950 | 0.3500 | 1.1980 | 1.1070 | −0.0590 | 0.0450 |
| Min | 0.8365 | 1.1665 | 0.3220 | 0.8440 | 1.1950 | 0.3470 | 1.1945 | 1.1025 | −0.0590 | 0.0450 |
| Max | 0.8415 | 1.1705 | 0.3320 | 0.8490 | 1.1970 | 0.3520 | 1.1980 | 1.1070 | −0.0550 | 0.0500 |
| Avg | 0.8383 | 1.1687 | 0.3263 | 0.8460 | 1.1963 | 0.3497 | 1.1965 | 1.1042 | −0.0565 | 0.0470 |

Cup Crimps Depth .205 DIA. 1.055

| | | | | | | | | | | |
|---|---|---|---|---|---|---|---|---|---|---|
| 1 | 0.8370 | 1.1675 | 0.3310 | 0.8450 | 1.2020 | 0.3565 | 1.2025 | 1.1030 | −0.0500 | 0.0520 |
| 2 | 0.8390 | 1.1735 | 0.3330 | 0.8480 | 1.2060 | 0.3575 | 1.2080 | 1.1070 | −0.0495 | 0.0520 |
| 3 | 0.8370 | 1.1740 | 0.3370 | 0.8455 | 1.2115 | 0.3655 | 1.2130 | 1.1030 | −0.0400 | 0.0640 |
| Min | 0.8370 | 1.1675 | 0.3310 | 0.8450 | 1.2020 | 0.3565 | 1.2025 | 1.1030 | −0.0500 | 0.0520 |
| Max | 0.8390 | 1.1740 | 0.3370 | 0.8480 | 1.2115 | 0.3655 | 1.2130 | 1.1070 | −0.0400 | 0.0640 |
| Avg | 0.8377 | 1.1717 | 0.3337 | 0.8462 | 1.2065 | 0.3598 | 1.2078 | 1.1043 | −0.0465 | 0.0560 |

Conventional Cup Crimps Depth .200 DIA. 1.045

| | | | | | | | | | | |
|---|---|---|---|---|---|---|---|---|---|---|
| 1 | 0.870 | 1.229 | 0.360 | 0.876 | 1.248 | 0.372 | 1.219 | 1.118 | −0.049 | 0.055 |
| 2 | 0.869 | 0.228 | 0.358 | 0.875 | 1.248 | 0.372 | 1.219 | 1.117 | −0.048 | 0.056 |
| 3 | 0.867 | 1.225 | 0.358 | 0.875 | 1.249 | 0.375 | 1.225 | 1.119 | −0.044 | 0.061 |
| Min | 0.867 | 0.228 | 0.358 | 0.875 | 1.248 | 0.372 | 1.219 | 1.117 | −0.049 | 0.055 |
| Max | 0.870 | 1.229 | 0.360 | 0.876 | 1.249 | 0.375 | 1.225 | 1.119 | −0.044 | 0.061 |
| Avg | 0.869 | 0.894 | 0.359 | 0.875 | 1.248 | 0.373 | 1.221 | 1.118 | −0.047 | 0.057 |

Conventional Cup Crimps Depth .205 DIA. 1.055

| | | | | | | | | | | |
|---|---|---|---|---|---|---|---|---|---|---|
| 1 | 0.8665 | 1.2355 | 0.3675 | 0.8745 | 1.2580 | 0.3850 | 1.2340 | 1.1280 | −0.0440 | 0.0600 |
| 2 | 0.8760 | 1.2395 | 0.3635 | 0.8820 | 1.2630 | 0.3800 | 1.2360 | 1.1320 | −0.0470 | 0.0570 |
| 3 | 0.8695 | 1.2400 | 0.3695 | 0.8750 | 1.2605 | 0.3845 | 1.2320 | 1.1230 | −0.0410 | 0.0580 |
| Min | 0.8665 | 1.2355 | 0.3635 | 0.8745 | 1.2580 | 0.3800 | 1.2320 | 1.1230 | −0.0470 | 0.0570 |
| Max | 0.8760 | 1.2400 | 0.3695 | 0.8820 | 1.2630 | 0.3850 | 1.2360 | 1.1320 | −0.0410 | 0.0600 |
| Avg | 0.8707 | 1.2383 | 0.3668 | 0.8772 | 1.2605 | 0.3832 | 1.2340 | 1.1277 | −0.0440 | 0.0583 |

In addition, in any of the above valve configurations, the mounting cup may be formed from sheet metal having a thickness of less than 0.016 in (0.406 mm) and greater than or equal to 0.005 in (0.127 mm). The sheet metal may be steel or other metal material. For example, the valve 410 of FIG. 14 may be formed from steel sheet metal having a thickness of about 0.010 in (0.254 mm), such that the mounting cup 414 resists deformation and does not significantly deform in use under a pressure of at least about 180 psi.

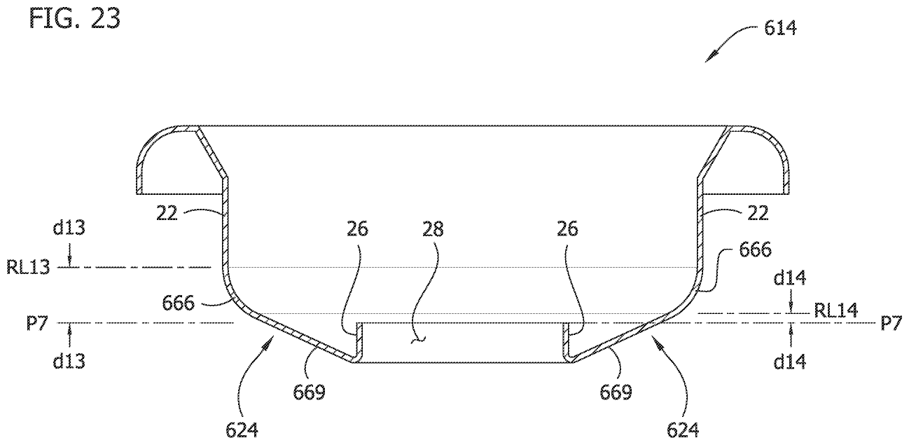

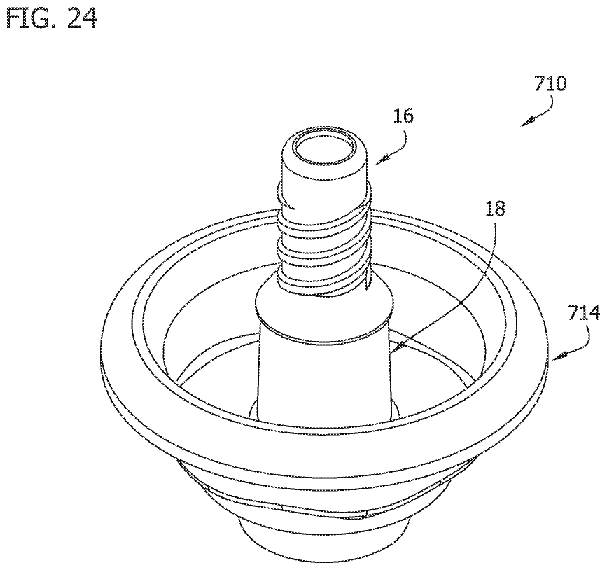

Referring to FIGS. 23 and 24, another valve is generally indicated at reference numeral 610. This valve 610 is similar to the third valve 210, with differences between the valves being disclosed below. Identical components and structures are indicated by corresponding reference numerals, and similar, but not identical, components and structures are indicated by corresponding reference numerals plus 400. Unless otherwise indicated, the teachings and disclosure set forth above with respect to the third valve 210 apply equally to the valve 610. The valve stem 16 and the seal 18 are identical to the stem and seal of the third valve 210.

Referring to FIG. 23, the main difference between the valve 610 and the third valve 210 is the mounting cup 614, and more specifically, the bottom wall 624. The annular sidewall-bottom transition portion 666 has a greater radius of curvature compared to the annular sidewall-bottom transition portion 266. The radial portion 669 has a constant slope like the third valve 210.

In one configuration, the upper end of the central portion 26 defining the opening 28 (e.g., the end of the central portion that is engaged by the external seal bead lies in a plane P7) is at (e.g., coplanar with) or below (e.g., entirely below) the upper radius line plane RL13. In another configuration, the upper end of the central portion 26 defining the opening 28 (e.g., the end of the central portion that is engaged by the external seal bead lies in a plane P7) is at (e.g., coplanar with) or below (e.g., entirely below) the lower radius line plane RL14. In still a further configuration, the upper end of the central portion 26 defining the opening 28 is below both the upper radius line plane RL13 and the lower radius line plane RL14.

In one configurations, a distance d13 between the upper radius line plane RL13 and the plane P7 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In another configuration, a distance d14 between the lower radius line plane RL14 and the plane P7 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

Referring to FIGS. 24-26, another valve is generally indicated at reference numeral 710. This valve 710 is similar to the third valve 210, with differences between the valves being disclosed below. Identical components and structures are indicated by corresponding reference numerals, and similar, but not identical, components and structures are indicated by corresponding reference numerals plus 500. Unless otherwise indicated, the teachings and disclosure set forth above with respect to the third valve 210 apply equally to the valve 710. The valve stem 16 and the seal 18 are identical to the stem and seal of the third valve 210.

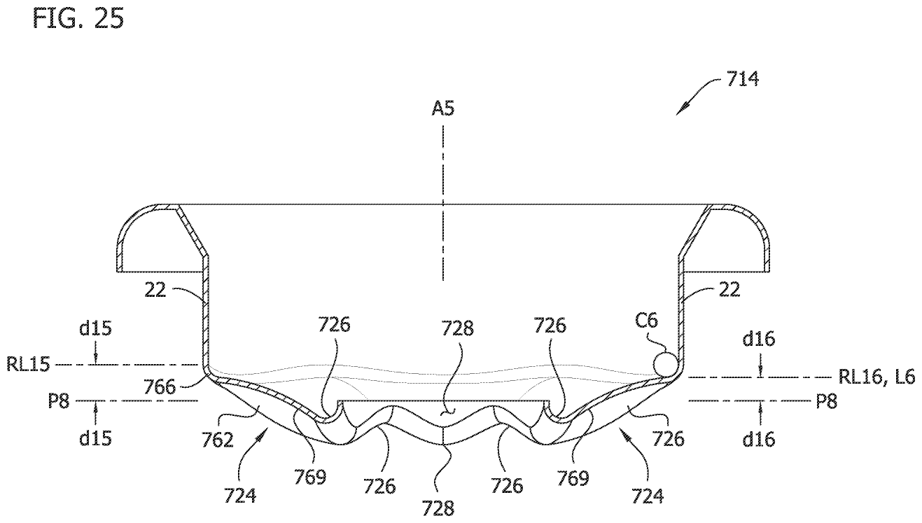

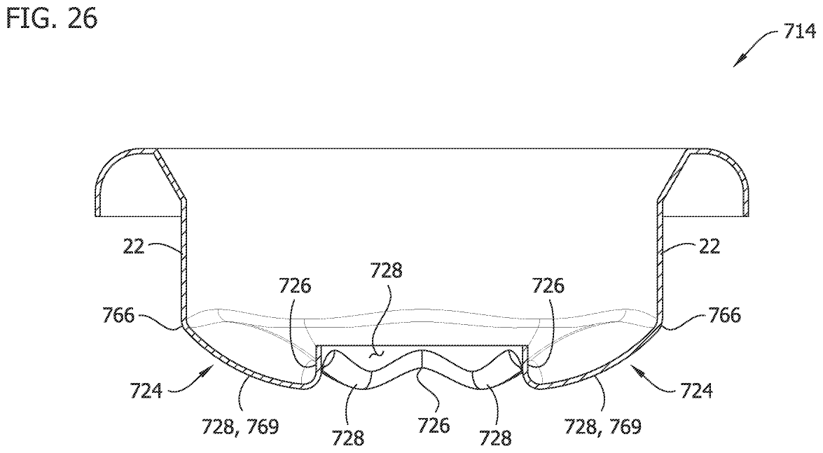

Referring to FIGS. 24 and 25, the main difference between the valve 610 and the third valve 210 is the mounting cup 714, and more specifically, the bottom wall 724. The bottom wall 724 has alternating concave radial segments 726 (e.g., grooves) and convex radial segments 728 (e.g., ridges), such that the radial portion 769 is corrugated with a plurality of radial folds. A sectional view taken through opposite concave radial segments 726 is illustrated in FIG. 25, and a sectional view taken through opposite convex radial segments 728 is illustrated in FIG. 26. It is believed the corrugated bottom wall 725 increases the rigidity to the bottom wall.

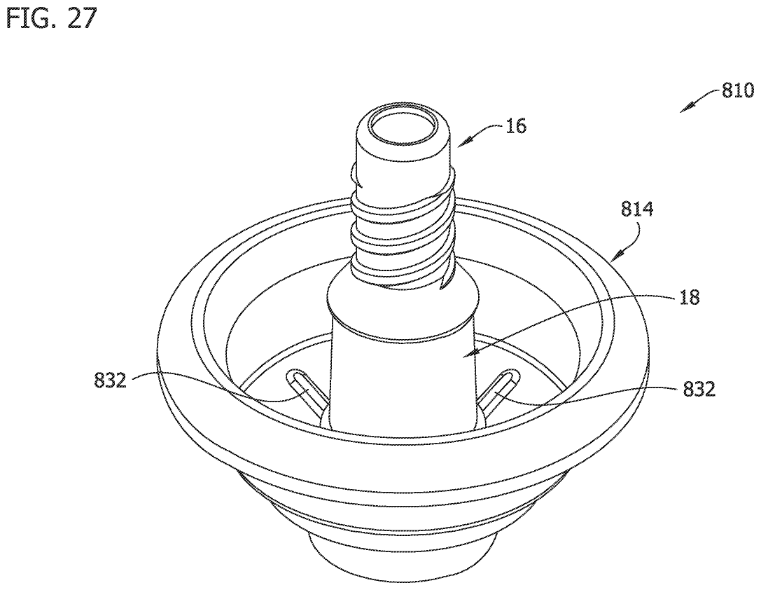

Referring still to FIG. 25, the upper end of the central portion 726 defining the opening 728 (e.g., the end of the central portion that is engaged by the external seal bead lies in a plane P8) is at (e.g., coplanar with) or below (e.g., entirely below) the upper radius line plane RL15. In one configuration, the upper end of the central portion 726 defining the opening 728 (e.g., the end of the central portion that is engaged by the external seal bead lies in a plane P8) is at (e.g., coplanar with) or below (e.g., entirely below) the lower radius line plane RL16. In another configuration, the upper end of the central portion 726 defining the opening 728 (e.g., the end of the central portion that is engaged by the external seal bead lies in a plane P8) is at (e.g., coplanar with) or below (e.g., entirely below) an imaginary line L6 perpendicular to the central axis A5 and tangent to a lower portion of an imaginary circle C6 defined by the radius of the annular sidewall-bottom transition portion 766. In FIG. 27, the imaginary line L6 and the lower radius line plane RL16 are coplanar, although in other configurations, the imaginary line L6 and the lower radius line may not be coplanar (i.e., spaced apart along the axis A5). In FIG. 27, the plane P8 is below (e.g., entirely below) the line L6 and lower radius line plane RL16.

In one configuration, a distance d15 between the upper radius line plane RL15 and the plane P8 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm. In another configuration, a distance d16 between the imaginary line L6 (and the lower radius line plane RL 16) and the plane P8 may be from about 0.0 mm to about 25.0 mm, or from about 0.25 mm to about 10.0 mm, or from about 0.25 mm to about 2.0 mm, or from about 0.1 mm to about 2.5 mm, or about 1.0 mm, or about 0.50 mm.

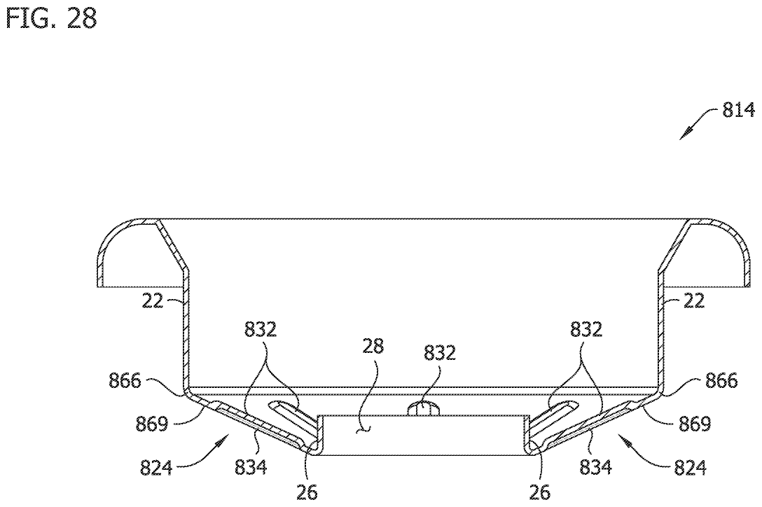

Referring to FIGS. 27 and 28, another valve is generally indicated at reference numeral 810. This valve 810 is similar to the third valve 210, with differences between the valves being disclosed below. Identical components and structures are indicated by corresponding reference numerals, and similar, but not identical, components and structures are indicated by corresponding reference numerals plus 600. Unless otherwise indicated, the teachings and disclosure set forth above with respect to the third valve 210 apply equally to the valve 810. The valve stem 16 and the seal 18 are identical to the stem and seal of the third valve 210.

Referring to FIG. 28, the main difference between the valve 810 and the third valve 210 is the mounting cup 814, and more specifically, the bottom wall 824. The bottom wall 824 has a plurality of ribs 832 formed on the bottom wall 824, more specifically, the inner radial portion 869 of the bottom wall. In the illustrated valve, the ribs 832 project upward from the inner radial portion 869 and corresponding grooves 834 are formed on the underside of the inner radial portion. In other configurations the ribs may project downward and corresponding grooves may be formed on the upper side of the inner radial portion. The ribs 832 are spaced apart from one another around the inner radial portion 869. It is believed that the ribs 832 increase the rigidity of the bottom wall 824. The other features and components of the mounting cup 814 may be identical to the mounting cup 214, and the description of the mounting cup 214 set forth above applies equally to the mounting cup 814.

### EXAMPLES

### Example 1

An example was conducted to compare the gas permeation of a container comprising a seal material comprising a thermoplastic vulcanizate (TPV) that is a nitrile/polyolefin-based TPV. The seals were tested for gas permeability to determine the weight loss from the container over a certain period of time.

The nitrile/polyolefin-based TPV was tested in its unmodified state (“Virgin”) and after drying utilizing a desiccant dryer (“Virgin Dried”). These results were compared to a nitrile/polyolefin-based TPV that had been subjected to the same drying procedure and extruded three times. That is, the TPV was passed through an extrusion device to produce a first extruded TPV, the first extruded TPV was passed through the extrusion device a second time to produce a second extruded TPV, and the second extruded TPV was passed through the extrusion device a third time to produce a third extruded material (reported as “Triple Pass”). The third extruded material was then injection molded to form a container seal for testing. The results of the seal testing are set forth below in Table 1, wherein the gas permeability is reported as grams of gas lost from the container per year. Each test was repeated multiple times to determine the average gas permeability of the material.

TABLE 1

| | Virgin | Virgin Dried | Triple Pass | Triple Pass |
|---|---|---|---|---|
| Number of Tests | 5 | 72 | 30 | 60 |
| Average | 5.86 | 9.53 | 7.86 | 7.63 |
| STDEV | 0.329 | 0.75 | 1.125 | 1.398 |
| Min | 5.39 | 7.821 | 6.43 | 5.30 |
| Max | 6.17 | 11.695 | 10.86 | 12.08 |

### Example 2

A test was also conducted to compare the “Virgin” and “Virgin Dried” nitrile/polyolefin-based TPV material to a material that had been subjected to three extrusion steps and combined with a regrind material prior to injection molding to form the container seal.

In this experiment, the nitrile/polyolefin-based TPV material was passed through an extrusion device to produce a first extruded TPV, the first extruded TPV was passed through the extrusion device a second time to produce a second extruded TPV, and the second extruded TPV was passed through the extrusion device a third time to produce a third extruded material. The third extruded material was then combined with a regrind material prior to injection molding to form the container seal. Regrind material is commonly understood to represent a material that has been processed at least once before. In this experiment, the regrind material was excess material from previous injection molding processes. Several experiments were conducted in this manner, altering the amount of regrind material that was combined with the third extruded material. Reported below in Table 2 are the results of a container seal comprising 20%, 40%, 60%, 80%, or 100% of regrind material. These percentages represent the amount of regrind material that was present in the combined material prior to injection molding to form the seal. For example, “20% Regrind” represents an experiment wherein the final material that was injection molded to form a container seal comprised 80% of a third extruded material and 20% of a regrind material.

TABLE 2

| | | Virgin | 20% | 40% | 60% | 80% | 100% |
|---|---|---|---|---|---|---|---|
| | Virgin | Dried | Regrind | Regrind | Regrind | Regrind | Regrind |
| Number of Tests | 5 | 72 | 12 | 12 | 12 | 12 | 12 |
| Average | 5.86 | 9.53 | 9.52 | 10.46 | 9.40 | 11.175 | 6.634 |
| STDEV | 0.329 | 0.75 | 3.17 | 5.389 | 2.426 | 4.171 | 2.156 |
| Min | 5.39 | 7.821 | 5.74 | 5.47 | 6.08 | 6.87 | 5.30 |
| Max | 6.17 | 11.695 | 16.95 | 22.60 | 13.82 | 21.38 | 13.04 |

When introducing elements of the invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

Having described the invention in detail, it will be apparent that modifications and variations are possible without departing from the scope of the invention defined in the appended claims.

As various changes could be made in the above constructions, products, and methods without departing from the scope of the invention, it is intended that all matter contained in the above description and shown in the accompanying drawings shall be interpreted as illustrative and not in a limiting sense.

1. A valve for dispensing flowable product from a container, the valve comprising:
a stem including a stem body and a disc at a lower portion of the stem body;
a seal attached to the stem body, the seal including a neck surrounding at least a longitudinal portion of the stem body, and a seat portion at the lower end of the neck defining a seat for the disc of the stem; and
a mounting cup configured to mount the valve to the container, the mounting cup including a bottom wall having a central portion defining a seal-mounting opening through which the seal and the stem extend,
wherein the seal comprises a material comprising a thermoplastic elastomer (TPE) selected from the group consisting of thermoplastic polyamides (TPAs), thermoplastic copolyesters (TPCs), olefinic thermoplastic elastomer (TPOs), styrenic block copolymers (TPSs), thermoplastic urethanes (TPUs), thermoplastic vulcanizates (TPVs), or nonclassified thermoplastic elastomers (TPZs).

2. The valve of claim 1, wherein the seal comprises a TPE comprising a TPV.

3. The valve of claim 2, wherein the TPV is a nitrile/polyolefin-based TPV.

4. The valve of claim 2, wherein the seal comprises a material comprising a TPV that is a nitrile/polyolefin-based TPV and a synthetic rubber selected from the group consisting of styrene-butadiene rubber, polyisoprene, polychloroprene (neoprene), nitrile rubber, and combinations thereof.

5. The valve of claim 2, wherein the seal comprises a material comprising a TPV that is a nitrile/polyolefin-based TPV and neoprene.

6. The valve of claim 1, wherein the seal comprises a thermoplastic elastomer having a density of from about 0.90 to about 1.10 g/cm³, from about 0.92 to about 1.10 g/cm³, from about 0.94 to about 1.10 g/cm³, from about 0.94 to about 1.08 g/cm³, or from about 0.94 to about 1.06 g/cm³.

7. The valve of claim 1, wherein the seal comprises a thermoplastic elastomer having a Shore A hardness, based on ISO 868 test protocol, of from about 40 to about 90, from about 45 to about 90, from about 45 to about 85, from about 50 to about 80, from about 55 to about 80, from about 60 to about 80, from about 65 to about 80, or from about 70 to about 80.

8. The valve of claim 1, wherein the seal comprises a thermoplastic elastomer having a brittleness temperature, based on ISO 812 test protocol, from about 0° C. to about −35° C., from about −5° C. to about −35° C., from about −10° C. to about −35° C., from about −15° C. to about −35° C., from about −20° C. to about −35° C., or from about −25° C. to about −35° C.

9. A process for preparing the seal of claim 1, wherein the method comprises extruding the material comprising a thermoplastic elastomer (TPE) and forming the seal.

10. The process of claim 9, wherein the material is extruded by an extrusion device selected from the group consisting of single screw, twin screw, or multi-screw extruder.

11. The process of claim 9, wherein the material is extruded by a twin screw extruder selected from the group consisting of a conical twin screw or parallel twin screw extruder.

12. The process of claim 11, wherein the twin screw extruder is a co-rotating or counter-rotating twin screw extruder.

13. The process of claim 9, wherein extruding the material comprising a TPE comprises passing the material through a first extrusion device to produce a first extruded material, passing the first extruded material through a second extrusion device to produce a second extruded material, and wherein the second extruded material is formed into the seal.

14. The process of claim 13, wherein the first and second extrusion device are the same or different.

15. The process of claim 9, wherein extruding the material comprising a TPE comprises passing the material through a first extrusion device to produce a first extruded material, passing the first extruded material through a second extrusion device to produce a second extruded material, and passing the second extruded material through a third extrusion device to produce a third extruded material, and wherein the third extruded material is formed into the seal.

16. The process of claim 15, wherein the first, second, and third extrusion device are the same or different.

17. The process of claim 9, wherein the extruded material is formed into the seal by a process comprising extrusion, injection molding, compression molding, blow molting, melt calendaring, thermoforming, heat welding, or any combination thereof.

18. A method for dispensing a flowable product from a valve of claim 1, comprising actuating the valve to dispense the flowable product.

19. The method of claim 18, wherein the flowable product comprises a one component polyurethane foam (OCF).

20. A seal for a valve for dispensing flowable product from a container, the seal comprising:
a neck configured to surround at least a longitudinal portion of a stem body of a stem of the valve; and
a seat portion at the lower end of the neck defining a seat for a disc of the stem,
wherein the seal comprises a material comprising a thermoplastic elastomer (TPE) selected from the group consisting of thermoplastic polyamides (TPAs), thermoplastic copolyesters (TPCs), olefinic thermoplastic elastomer (TPOs), styrenic block copolymers (TPSs), thermoplastic urethanes (TPUs), thermoplastic vulcanizates (TPVs), or nonclassified thermoplastic elastomers (TPZs).
